(19) United States
(12) Patent Application Publication
(10) Pub. No.: US 2016/0363760 A1
(43) Pub. Date: Dec. 15, 2016

(54) OPTICAL MODULE AND ELECTRONIC DEVICE

(71) Applicant: Seiko Epson Corporation, Tokyo (JP)

(72) Inventors: Tomonori MATSUSHITA, Chino (JP); Masashi KANAI, Azumino (JP)

(21) Appl. No.: 14/339,731

(22) Filed: Jul. 24, 2014

(30) Foreign Application Priority Data
Jul. 29, 2013 (JP) 2013-156418

(51) Int. Cl. G02B 26/00; G01J 3/26; G02B 5/28

(52) U.S. Cl. CPC G02B 26/001; G02B 5/288; G01J 3/26

(57) ABSTRACT

An optical module includes a variable wavelength interference filter configured to transmit light including peak wavelengths corresponding to a gap dimension between a pair of reflection films and corresponding to a plurality of orders and first to third dichroic mirrors configured to separate light in a predetermined wavelength band and lights in wavelength bands other than the predetermined wavelength band. The plurality of first to third dichroic mirrors respectively correspond to different orders and are arranged in order such that the peak wavelengths corresponding to the orders are included in the predetermined wavelength band and transmitted light of the variable wavelength interference filter is made incident on the first dichroic mirror, second separated light of the first dichroic mirror is made incident on the second dichroic mirror, and second separated light of the second dichroic mirror is made incident on the third dichroic mirror.

### BACKGROUND

1. Technical Field

The present invention relates to an optical module and an electronic device.

2. Related Art

There has been known a device that measures a spectral spectrum using a variable wavelength interference filter (see, for example, JP-A-2012-127917 (Patent Literature 1)).

The device described in Patent Literature 1 includes a first filter (a variable wavelength interference filter) of a variable Fabry-Perot type including mirrors arranged to be opposed to each other and a second filter including a plurality of band-pass sections that selectively transmit light in a predetermined band. The second filter is arranged to be opposed to the variable wavelength interference filter. The plurality of band-pass sections are configured to respectively transmit interference lights of different orders and are arranged to respectively correspond to different parts of the variable wavelength interference filter. Specifically, the plurality of band-pass filters are arranged in parallel in a direction orthogonal to an optical path of the transmitted light of the variable wavelength interference filter.

In the device described in Patent Literature 1 configured as explained above, the plurality of band-pass sections are arranged to respectively correspond to the different parts of the variable wavelength interference filter. Therefore, each of the plurality of band-pass sections transmits interference light of an order corresponding to the band-pass section out of light including interference lights of a plurality of orders. The device receives lights transmitted through the band-pass sections to simultaneously perform measurement concerning a plurality of wavelengths.

For example, it is conceivable to attain a reduction in a measurement time by simultaneously performing the measurement concerning the plurality of wavelengths using the device described in Patent Literature 1.

However, in the device described in Patent Literature 1, the band-pass sections are arranged in parallel. Therefore, transmitted light from a part of regions among the transmitted lights of the variable wavelength interference filter is received by a light receiving section via one band-pass section. When the transmitted light is received, since interference lights (transmitted lights) of orders other than orders corresponding to the band-pass sections are removed in the band-pass sections, a light reception amount decreases. Therefore, when the measurement is performed in a short time, a sufficient light reception amount cannot be obtained and highly accurate spectrometry cannot be carried out. To suppress such deterioration in spectral accuracy, a light reception time by the light receiving section needs to be increased. Therefore, the measurement cannot be performed in a short time.

As explained above, the device described in Patent Literature 1 cannot reduce the light reception time while maintaining the spectral accuracy.

### SUMMARY

An advantage of some aspects of the invention is to provide an optical module and an electronic device that can suppress a decrease in a light amount when light including peak wavelengths corresponding to a plurality of orders is separated and extracted.

An aspect of the invention is directed to an optical module including: an interference filter including a first reflection film and a second reflection film opposed to the first reflection film, the interference filter transmitting light including peak wavelengths corresponding to a gap dimension between the first reflection film and the second reflection film and respectively corresponding to a plurality of orders; and a light separating element configured to separate light in a predetermined wavelength band and light in a wavelength band other than the predetermined wavelength band. A plurality of the light separating elements are provided to respectively correspond to the orders different from one another. The peak wavelengths corresponding to the orders are included in the predetermined wavelength band in the light separating element. The plurality of light separating elements are arranged in order on an optical path of transmitted light of the interference filter.

In the aspect of the invention, the plurality of light separating elements respectively correspond to the different orders. This means that, in the plurality of light separating elements that separate light including peak wavelengths corresponding to one or two or more orders and the other lights, the orders respectively corresponding to the light separating elements do not completely coincide with one another and at least a part of the orders are different.

The optical path of the transmitted light of the interference filter includes optical paths of the transmitted light itself of the interference filter, light obtained by separating the transmitted light with the light separating element, that is, separated light, which is a part of the transmitted light. The optical path of the transmitted light also includes an optical path obtained by changing the optical path of the transmitted light with a mirror.

In the aspect of the invention, in the optical module, the plurality of light separating elements are arranged in order on the optical path of the transmitted light of the interference filter. In the plurality of light separating elements, different predetermined wavelength bands are respectively set to correspond to the plurality of orders included in the transmitted light of the interference filter. That is, the light separating element is configured such that a peak wavelength corresponding to at least one of the plurality of orders in the transmitted light transmitted through the interference filter is included in the predetermined wavelength band.

In such a configuration, it is possible to simultaneously acquire lights including peak wavelengths corresponding to the plurality of orders.

In such a configuration, it is possible to arrange the light separating elements to make all transmitted lights of the interference filter incident thereon. Consequently, compared with outputting light corresponding to a specific order from a part of the transmitted light transmitted through the interference filter, a light amount of the light corresponding to the order increases.

Therefore, the optical module according to the aspect of the invention can simultaneously output lights including a plurality of peak wavelengths and suppress a decrease in light amounts of the peak wavelengths.

In the configuration in the past in which all light separating elements are arranged in parallel, a part of separated lights of the light separating elements is acquired and apart of the separated lights is removed. Therefore, light in an acquisition target wavelength band included in the removed part cannot be acquired.

In the aspect of the invention, since the plurality of light separating elements are arranged in order such that separated light of a light separating element is made incident on the other light separating elements, light including a peak wavelength of an order included in separated light removed in the configuration in the past can be extracted by the light separating element on which the separated light is made incident. Therefore, it is possible to increase a light amount that can be acquired.

In the optical module according to the aspect of the invention, it is preferable that the interference filter includes a light-transmitting member arranged between the first reflection film and the second reflection film.

As the light-transmitting member, a light-transmitting member having a refractive index larger than the refractive index of a medium between the reflection films is used. For example, when the interference filter is used in a vacuum state, a refractive index larger than “1”, which is the refractive index of the vacuum, is used.

In the configuration described above, the light-transmitting member can increase a refractive index between the reflection films and increase an optical path length of light passing between the reflection films. Consequently, even if an inter-reflection film distance is not expanded compared with that in the vacuum, an order of light included in transmitted light can be set high.

Light including a peak wavelength of a high order has a smaller wavelength change with respect to fluctuation in the gap dimension between the reflection films than light including a peak wavelength of a low order. Therefore, even when the gap dimension fluctuates because of an external factor such as vibration or a temperature change, by configuring the optical module to output light including peak wavelengths of high orders, it is possible to suppress a wavelength change of the output light including the peak wavelengths.

In the aspect of the invention, when light in a predetermined target wavelength region is output from transmitted light, by including more peak wavelengths in the target wavelength region, it is possible to simultaneously output lights including more wavelengths. Outputting light including a plurality of peak wavelengths from the target wavelength region using a peak wavelength of a low order and outputting light including a plurality of peak wavelengths from the target wavelength region using a peak wavelength of a higher order are compared.

In the former case, an interval among the peak wavelengths (FSR: Free Spectral Range) is large. Depending on a target wavelength region, the number of peak wavelengths in the target wavelength region is small. In this case, for example, when the gap dimension between the reflection films is sequentially changed, light amounts of output light including peak wavelengths are detected, and a spectral spectrum is measured, since the number of peak wavelengths that can be simultaneously measured is small, the number of times of the gap dimension is changed (the number of times of measurement) increases and a measurement time increases.

On the other hand, in the latter case, since the FSR is small, a large number of peak wavelengths are included in the target wavelength region. Therefore, when lights including the peak wavelengths are respectively separated by the light separating elements, the number of lights including peak wavelengths that can be detected at a time also increases. Therefore, for example, even when a spectral spectrum is measured, the number of times of measurement can be reduced and a reduction in the measurement time can be attained.

In the optical module according to the aspect of the invention, it is preferable that the optical module further includes a first light-transmitting member configured to cover the first reflection film and a second light-transmitting member configured to cover the second reflection film and opposed to the first light-transmitting member via a predetermined optical gap.

In the configuration described above, the first reflection film and the second reflection film are respectively covered by the first light-transmitting member and the second light-transmitting member. Therefore, it is possible to cause the light-transmitting members to function as protection films for the reflection films. It is possible to suppress deterioration of the reflection films.

In the optical module according to the aspect of the invention, it is preferable that the interference filter includes a gap changing section configured to change the gap dimension, the first light-transmitting member and the second light-transmitting member have electric conductivity, and the optical module includes a capacitance detecting section configured to detect a capacitance between the first light-transmitting member and the second light-transmitting member.

In the configuration described above, in the interference filter, the gap dimension between the reflection films can be changed by the gap changing section. The capacitance between the conductive first and second light-transmitting members is measured by the capacitance detecting section. As explained above, to include a peak wavelength of a high order in a predetermined target wavelength region in transmitted light transmitted through the interference filter, it is preferable to increase an optical distance between the reflection films. However, for example, when the reflection films are conductive films and the gap dimension between the reflection films is detected by the capacitance detecting section, the gap dimension between the reflection films and a charge amount retained by the reflection films are inversely proportional to each other. Therefore, as the gap dimension increases, detection accuracy of capacitance detection is further deteriorated.

On the other hand, in the configuration described above, the capacitance between the first light-transmitting member and the second light-transmitting member provided to cover the reflection films is detected. Therefore, since the distance between the first light-transmitting member and the second light-transmitting member is smaller than the gap dimension between the first reflection film and the second reflection film, it is possible to improve the detection accuracy of the capacitance detection compared with the case explained above.

In the optical module according to the aspect of the invention, it is preferable that a singularity of the peak wavelength corresponding to the order in the interference filter is included in the predetermined wavelength band in the light separating element.

In the configuration described above, wavelength bands for separating lights in the light separating elements are set such that one peak wavelength in the transmitted light of the interference filter is included in the wavelength bands for separating the lights in the light separating elements. Therefore, one peak wavelength is separated by each of the light separating elements. It is possible to easily acquire light including a desired peak wavelength.

In the optical module according to the aspect of the invention, it is preferable that the light separating element is a dichroic mirror, and a plurality of the dichroic mirrors are arranged from the interference filter side of the optical path in order from the dichroic mirror having lowest reflectance of light in a wavelength band other than the predetermined wavelength band.

With such a configuration, it is possible to suppress the light in the wavelength band other than the predetermined wavelength band from being included in separated light separated by the dichroic mirror. It is possible to highly accurately output light including a desired wavelength. The light in the wavelength band other than the predetermined wavelength band is not reflected but is transmitted by the dichroic mirror arranged on the interference filter side. Therefore, it is possible to suppress a decrease in light amounts of transmitted lights of the dichroic mirrors. Further, it is possible to more surely separate light including the peak wavelengths corresponding to the orders.

Another aspect of the invention is directed to an optical module including: an interference filter including a first reflection film and a second reflection film opposed to the first reflection film, the interference filter transmitting light including peak wavelengths corresponding to a gap dimension between the first reflection film and the second reflection film and respectively corresponding to a plurality of orders; and a light separating element configured to separate light in a predetermined wavelength band and light in a wavelength band other than the predetermined wavelength band. A plurality of the light separating elements are provided to respectively correspond to the orders different from one another. The peak wavelengths corresponding to the orders are included in the predetermined wavelength band in the light separating element. The plurality of light separating elements include a first light separating element on which transmitted light of the interference filter is made incident and a second light separating element on which light separated by the first light separating element is made incident.

In the aspect of the invention, the optical module includes the plurality of light separating elements. The transmitted light of the interference filter is made incident on the first light separating element, which is one of the plurality of light separating elements. The separated light separated by the first light separating element is made incident on the second light separating element. In the plurality of light separating elements, predetermined different wavelength bands are respectively set to correspond to the plurality of orders included in the transmitted light of the interference filter. That is, the light separating element is configured such that a peak wavelength corresponding to at least one of the plurality of orders in the transmitted light transmitted by the interference filter is included in the predetermined wavelength band.

In such a configuration, as in aspect of the invention explained above, it is possible to simultaneously output lights including a plurality of peak wavelengths. It is possible to suppress a decrease in light amounts of the peak wavelengths.

The optical module is configured such that the light separated by the first light separating element is made incident on the second light separating element. As in the aspect of the invention explained above, it is possible to acquire, with the second light separating element, light including a peak wavelength of an order associated with the second light separating element from separated light removed in the related art. Therefore, it is possible to increase a light amount that can be acquired.

Still another aspect of the invention is directed to an electronic device including: an interference filter including a first reflection film and a second reflection film opposed to the first reflection film, the interference filter transmitting light including peak wavelengths corresponding to a gap dimension between the first reflection film and the second reflection film and respectively corresponding to a plurality of orders; a light separating element configured to separate light in a predetermined wavelength band and light in a wavelength band other than the predetermined wavelength band; and a control section configured to control the interference filter. A plurality of the light separating elements are provided to respectively correspond to the orders different from one another. The peak wavelengths corresponding to the orders are included in the predetermined wavelength band in the light separating element. The plurality of light separating elements are arranged in order on an optical path of transmitted light of the interference filter.

In the aspect of the invention, as in the aspects of the invention explained above, it is possible to simultaneously acquire light amount values of a plurality of peak wavelengths. It is possible to suppress a decrease in light amounts of the peak wavelengths. Therefore, in the electronic device in the aspect of the invention including such an optical module, it is possible to carry out highly accurate and quick processing. For example, when a spectral spectrum is measured on the basis of light amounts of lights separated by the light separating elements, it is possible to carry out highly accurate spectral spectrometry based on a sufficient light amount. It is possible to simultaneously detect a plurality of peak wavelengths. Therefore, it is possible to attain an increase in speed of measurement.

### BRIEF DESCRIPTION OF THE DRAWINGS

The invention will be described with reference to the accompanying drawings, wherein like numbers reference like elements.

FIG. 1 is a block diagram showing the schematic configuration of a spectrometry device according to an embodiment of the invention.

FIG. 2 is a plan view showing the schematic configuration of a variable wavelength interference filter in the embodiment.

FIG. 3 is a sectional view showing the schematic configuration of the variable wavelength interference filter in the embodiment.

FIG. 4 is a graph showing an example of a spectrum of transmitted light of the variable wavelength interference filter.

FIG. 5 is a graph showing an example of a reflection characteristic (in a first band) of a dichroic mirror.

FIG. 6 is a graph showing an example of a reflection characteristic (in a second band) of the dichroic mirror.

FIG. 7 is a graph showing an example of a reflection characteristic (in a third band) of the dichroic mirror.

FIG. 8 is a graph showing an example of a measurement result in a first fluctuation band shown in FIG. 4.

FIG. 9 is a graph showing an example of a measurement result in a second fluctuation band shown in FIG. 4.

FIG. 10 is a graph showing an example of a measurement result in a third fluctuation band shown in FIG. 4.

FIG. 11 is a graph showing an example of a measurement result in a fourth fluctuation band shown in FIG. 4.

FIG. 12 is a flowchart showing an example of spectrometry processing in the spectrometry device.

FIG. 13 is a graph showing a relation between a change amount of a gap dimension and a wavelength change amount in a first-order peak wavelength and a plurality of high-order peak wavelength.

FIG. 14 is a graph showing a relation between gap dimension accuracy and a color difference in the first-order peak wavelength and the high-order peak wavelength.

FIG. 15 is a block diagram showing a colorimetric device, which is an example of an electronic device in the embodiment.

FIG. 16 is a schematic diagram showing a gas detecting device, which is an example of the electronic device in the embodiment.

FIG. 17 is a block diagram showing the configuration of a control system of a gas detecting device shown in FIG. 16.

FIG. 18 is a diagram showing the schematic configuration of a food analyzing device, which is an example of the electronic device in the embodiment.

### DESCRIPTION OF EXEMPLARY EMBODIMENTS

An embodiment of the invention is explained below with reference to the drawings.

### Configuration of a Spectrometry Device

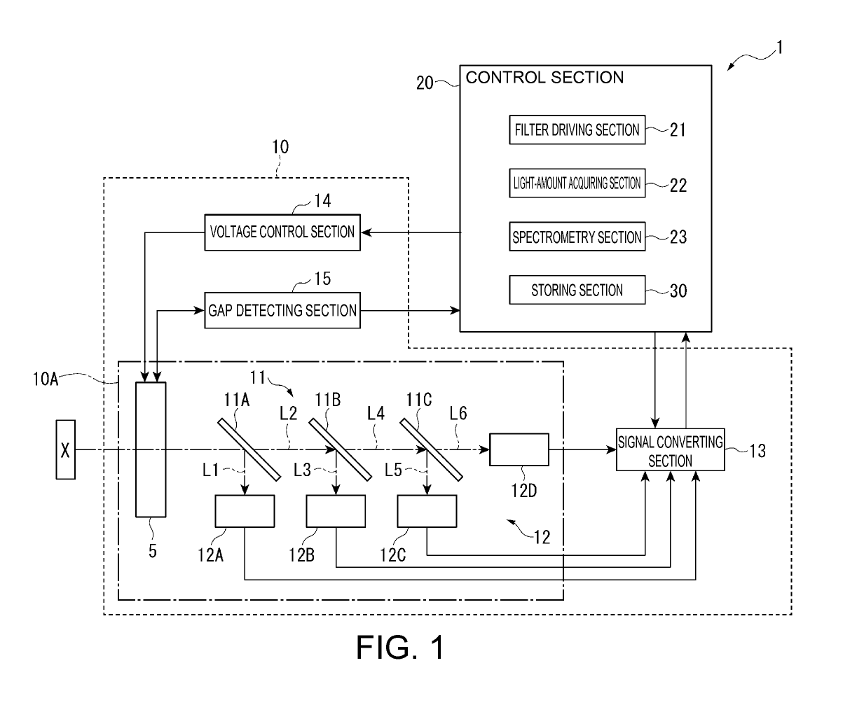

FIG. 1 is a block diagram showing the schematic configuration of a spectrometry device according to the embodiment of the invention.

A spectrometry device 1 is an electronic device in this embodiment and is a device that measures, on the basis of measurement target light reflected on a measurement target X, a spectrum of the measurement target light. In this embodiment, an example is explained in which the measurement target light reflected on the measurement target X is measured. However, when a light-emitting body such as a liquid crystal panel is used as the measurement target X, light emitted from the light-emitting body may be the measurement target light.

The spectrometry device 1 includes, as shown in FIG. 1, an optical module 10 and a control section 20.

### Configuration of the Optical Module

The optical module 10 includes a variable wavelength interference filter 5, a light separating section 11, a light receiving section 12, a signal converting section 13, a voltage control section 14, and a gap detecting section 15.

The optical module 10 leads the measurement target light to the variable wavelength interference filter 5 via an incident optical system (not shown in the figure) and causes the variable wavelength interference filter 5 to transmit light including peak wavelengths respectively corresponding to a plurality of orders (light centering on the peak wavelengths) from the measurement target light. The light separating section 11 separates the light including the peak wavelengths respectively corresponding to the orders included in the transmitted light. The light receiving section 12 individually receives the separated light including the peak wavelengths. The variable wavelength interference filter 5, the light separating section 11, and the light receiving section 12 configure an optical unit 10A.

### Configuration of the Variable Wavelength Interference Filter

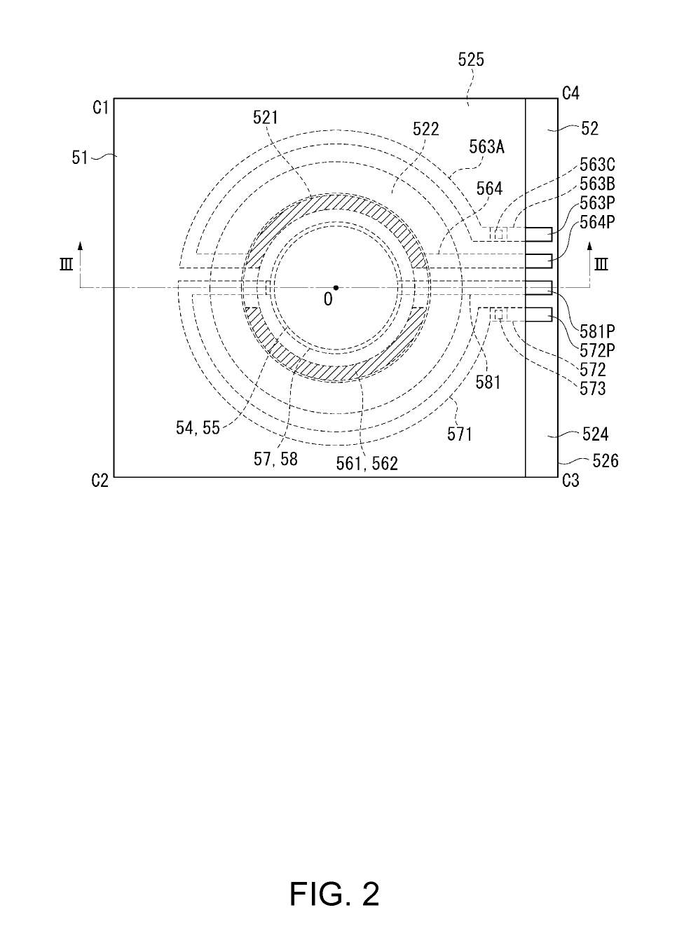

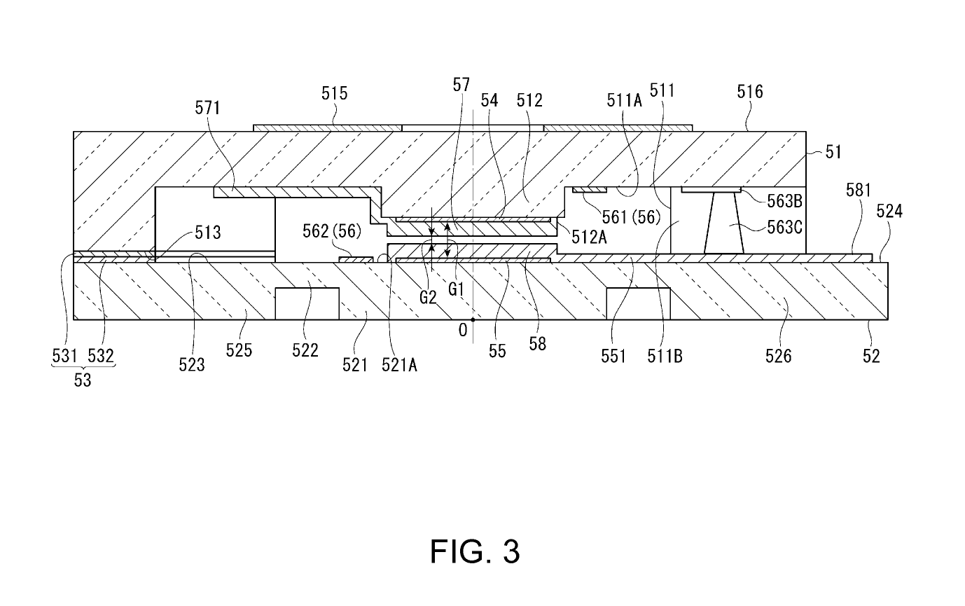

The variable wavelength interference filter 5 is an example of the interference filter according to the invention. FIG. 2 is a plan view showing the schematic configuration of the variable wavelength interference filter 5. FIG. 3 is a sectional view showing the schematic configuration of the variable wavelength interference filter 5 taken along line in FIG. 2.

As shown in FIG. 2, the variable wavelength interference filter 5 is, for example, an optical member having a rectangular tabular shape. The variable wavelength interference filter 5 includes a fixed substrate 51 and a movable substrate 52. Each of the fixed substrate 51 and the movable substrate 52 is formed of any one of various kinds of glass such as soda glass, crystalline glass, quartz glass, lead glass, potassium glass, borosilicate glass, and alkali-free glass, crystal, or the like. As shown in FIG. 3, the fixed substrate 51 and the movable substrate 52 are joined by a joining film 53 (a first joining film 531 and a second joining film 532) to be integrally formed. Specifically, a first joining section 513 of the fixed substrate 51 and a second joining section 523 of the movable substrate 52 are joined by the joining film 53 formed by a plasma polymerized film or the like containing siloxane as a main component.

In the following explanation, a plan view from the thickness direction of the fixed substrate 51 or the movable substrate 52, that is, a plan view of the variable wavelength interference filter 5 viewed from a laminating direction of the fixed substrate 51, the joining film 53, and the movable substrate 52 is referred to as filter plan view.

On the fixed substrate 51, as shown in FIG. 3, a fixed reflection film 54 as an example of the first reflection film according to the invention is provided. On the movable substrate 52, a movable reflection film 55 as an example of the second reflection film according to the invention is provided. The fixed reflection film 54 and the movable reflection film 55 are arranged to be opposed to each other via an inter-reflection film gap G1.

In the variable wavelength interference filter 5, an electrostatic actuator 56 (example of the gap changing section according to the invention) used to adjust the distance (a gap dimension) of the inter-reflection film gap G1 is provided. The electrostatic actuator 56 includes a fixed electrode 561 provided on the fixed substrate 51 and a movable electrode 562 provided in the movable substrate 52. The electrostatic actuator 56 is configured by opposing the electrodes 561 and 562 (a hatched region in FIG. 2). The fixed electrode 561 and the movable electrode 562 are opposed to each other via an inter-electrode gap. The electrodes 561 and 562 may be respectively directly provided on the surfaces of the fixed substrate 51 and the movable substrate 52 or may be provided via other film members.

In an example explained in this embodiment, the inter-reflection film gap G1 is formed smaller than the inter-electrode gap. However, for example, depending on a wavelength region transmitted by the variable wavelength interference filter 5, the inter-reflection film gap G1 may be formed larger than the inter-electrode gap.

In the filter plan view, one side (e.g., aside C3-C4 in FIG. 2) of the movable substrate 52 projects further to the outer side than the fixed substrate 51. A projecting portion of the movable substrate 52 is an electric equipment section 526 not jointed to the fixed substrate 51. In the electric equipment section 526 of the movable substrate 52, a surface exposed when the variable wavelength interference filter 5 is viewed from the fixed substrate 51 side is an electric equipment surface 524. Below-mentioned electrode pads 572P, 581P, 563P, and 564P are provided on the electric equipment surface 524.

### Configuration of the Fixed Substrate

The fixed substrate 51 is formed by machining a glass base material formed at thickness of, for example, 500 μm. Specifically, as shown in FIG. 3, in the fixed substrate 51, an electrode arrangement groove 511 and a reflection-film setting section 512 are formed by etching. The thickness dimension of the fixed substrate 51 is formed large compared with the movable substrate 52. The fixed substrate 51 is not bent by electrostatic attraction generated when a voltage is applied between the fixed electrode 561 and the movable electrode 562 or internal stress of the fixed electrode 561.

The electrode arrangement groove 511 is formed in an annular shape centering on a plane center point O of the variable wavelength interference filter 5 in the filter plan view. As shown in FIG. 3, the reflection-film setting section 512 is formed to project to the movable substrate 52 side from the center of the electrode arrangement groove 511 in the plan view. The groove bottom surface of the electrode arrangement groove 511 is an electrode setting surface 511A on which the fixed electrode 561 is arranged. The projecting distal end face of the reflection film setting section 512 is a reflection film setting surface 512A.

In the fixed substrate 51, an electrode draw-out grove 511B extending from the electrode arrangement groove 511 toward the electric equipment surface 524 is provided.

On the electrode setting surface 511A of the electrode arrangement groove 511, the fixed electrode 561 is provided around the reflection-film setting section 512. The fixed electrode 561 is provided in a region of a below-mentioned movable section 521 opposed to the movable electrode 562 on the electrode setting surface 511A. The fixed electrode 561 is formed in a substantially C-shape having an opening on a side C1-C2 side shown in FIG. 2. On the fixed electrode 561, an insulation film for securing insulation between the fixed electrode 561 and the movable electrode 562 may be laminated.

On the fixed substrate 51, a fixed extraction electrode 563A extending from the outer circumferential edge near the C-shape opening section of the fixed electrode 561 toward the side C3-C4 shown in FIG. 2 is provided. An extended distal end portion (a portion located on the side C3-C4 of the fixed substrate 51) of the fixed extraction electrode 563A is electrically connected to, via a bump electrode 563C, a fixed connection electrode 563B provided on the movable substrate 52 side. The fixed connection electrode 563B extends to the electric equipment surface 524 through the electrode draw-out groove 511B and forms a fixed electrode pad 563P on the electric equipment surface 524. The fixed electrode pad 563P is connected to the voltage control section 14.

In this embodiment, one fixed electrode 561 is provided on the electrode setting surface 511A. However, for example, two electrodes forming concentric circles centering on the plane center point O may be provided (a double electrode configuration).

As explained above, the reflection-film setting section 512 includes the reflection film setting surface 512A formed coaxially with the electrode arrangement groove 511 in a substantially columnar shape, which has a diameter dimension smaller than the electrode arrangement groove 511, and opposed to the movable substrate 52 of the reflection-film setting section 512.

As shown in FIG. 3, the fixed reflection film 54 is set in the reflection-film setting section 512. As the fixed reflection film 54, for example, a metal film of Ag or the like or an alloy film of an Ag alloy or the like can be used. For example, a dielectric multilayer film including a high refraction layer formed of TiO2 and a low refraction layer formed of SiO2 may be used. Further, for example, a reflection film formed by laminating the metal film (or the alloy film) on the dielectric multilayer film, a reflection film formed by laminating the dielectric multilayer film on the metal film (or the alloy film), or a reflection film formed by laminating a single refraction layer (TiO2, SiO2, etc.) and the metal film (or the alloy film) may be used.

On the fixed substrate 51, a fixed conductive film 57 (the first light-transmitting member) that covers the fixed reflection film 54 is provided. The fixed conductive film 57 is formed of a light-transmitting conductive material capable of transmitting light, for example, indium tin oxide (ITO). The fixed conductive film 57 is provided in a region where light passes between the reflection films 54 and 55.

The fixed conductive film 57 is a member having a refractive index n larger than 1. Therefore, it is possible to increase an optical path length of light passing between the reflection films 54 and 55. As the light-transmitting conductive material, besides ITO, for example, indium gallium oxide (IGO), Ce doped indium oxide (ICO), and fluorine doped indium oxide (IFO), which are indium-based oxides, antimony doped tin oxide (ATO), fluorine doped tin oxide (FTO), and tin oxide (SnO2), which are tin-based oxides, and Al doped zinc oxide (AZO), Ga doped zinc oxide (GZO), fluorine doped zinc oxide (FZO), and zinc oxide (ZnO), which are zinc-based oxides are used. Indium zinc oxide (IZO: registered trademark) formed of an indium-based oxide and a zinc-based oxide can also be used.

The fixed conductive film 57 preferably has a thickness dimension twice or more as large as the thickness dimension of the fixed reflection film 54. For example, when the fixed reflection film 54 is formed of an Ag alloy film and the fixed conductive film 57 is formed of ITO, the fixed reflection film 54 is formed at a thickness dimension of 30 nm and the fixed conductive film 57 is formed at a thickness dimension of 200 nm.

A fixed capacitance electrode 571 is connected to the fixed conductive film 57. The fixed capacitance electrode 571 extends toward the side C1-C2 through the C-shape opening section of the fixed electrode 561 and then extends toward the side C3-C4. An extended distal end portion (a portion located on the side C3-C4 of the fixed substrate 51) of the fixed capacitance electrode 571 is electrically connected to a fixed capacitance connection electrode 572, which is provided on the movable substrate 52 side, via a bump electrode 573. The fixed capacitance connection electrode 572 extends to the electric equipment surface 524 through the electrode draw-out groove 511B, forms a fixed capacitance electrode pad 572P on the electric equipment surface 524, and is connected to the gap detecting section 15.

The fixed conductive film 57 is opposed to a below-mentioned movable conductive film 58. For example, by applying a high-frequency voltage not affecting the driving of the electrostatic actuator 56 to the pair of conductive films 57 and 58, it is possible to cause the pair of conductive films 57 and 58 to retain charges. That is, the pair of conductive films 57 and 58 function as an electrostatic capacitance measurement electrode for detecting capacitance generated between the pair of conductive films 57 and 58. By detecting the capacitance between the pair of conductive films 57 and 58 with the gap detecting section 15, it is possible to calculate a dimension of a gap G2 between the conductive films 57 and 58 and calculate a gap dimension of the inter-reflection film gap G1.

As shown in FIG. 3, a surface of the fixed substrate 51 on which the fixed reflection film 54 is not provided is a light incident surface 516. On the light incident surface 516, a reflection prevention film may be formed in a position corresponding to the fixed reflection film 54. The reflection prevention film can be formed by alternately laminating a low refractive index film and a high refractive index film. The reflection prevention film reduces the reflectance of visible light on the surface of the fixed substrate 51 and increases transmittance of the visible light.

Further, on the light incident surface 516 of the fixed substrate 51, as shown in FIG. 3, a non-light-transmitting member 515 formed of chrome oxide or the like may be provided (in FIG. 2, the non-light-transmitting member 515 is not shown). The non-light-transmitting member 515 is formed in an annular shape and preferably formed in a ring shape. The annular inner circumference diameter of the non-light-transmitting member 515 is set to an effective diameter for causing light interference of the fixed reflection film 54 and the movable reflection film 55. Consequently, the non-light-transmitting member 515 functions as an aperture configured to narrow incident light made incident on the variable wavelength interference filter 5.

In the surface of the fixed substrate 51 opposed to the movable substrate 52, a surface in which the electrode arrangement groove 511, the reflection-film setting section 512, and the electrode draw-out grove 511B are not formed forms the first joining section 513. The first joining film 531 is provided in the first joining section 513. The first joining film 531 is joined to the second joining film 532 provided on the movable substrate 52, whereby the fixed substrate 51 and the movable substrate 52 are joined as explained above.

### Configuration of the Movable Substrate

The movable substrate 52 is formed by machining a glass base material formed at thickness of, for example, 200 μm.

Specifically, the movable substrate 52 includes a movable section 521 having a circular shape centering on the plane center point O in the filter plan view shown in FIG. 2, a retaining section 522 provided on the outer side of the movable section 521 and configured to retain the movable section 521, and a substrate outer circumference section 525 provided on the outer side of the retaining section 522.

The movable section 521 is formed larger in a thickness dimension than the retaining section 522. For example, in this embodiment, the movable section 521 is formed in a thickness dimension same as the thickness dimension of the movable substrate 52. The movable section 521 is formed in a diameter dimension larger than at least the diameter dimension of the outer circumferential edge of the reflection film setting surface 512A. The movable electrode 562 and the movable reflection film 55 are provided in the movable section 521.

Like the fixed substrate 51, a reflection prevention film may be formed on a surface of the movable section 521 on the opposite side of the fixed substrate 51. The reflection prevention film can be formed by alternately laminating a low refractive index film and a high refractive index film. The reflection prevention film can reduce the reflectance of visible light on the surface of the movable substrate 52 and increase the transmittance of the visible light. In this embodiment, a surface of the movable section 521 opposed to the fixed substrate 51 is a movable surface 521A.

The movable electrode 562 is opposed to the fixed electrode 561 via an inter-electrode gap and formed in a substantially C-shape having an opening on the side C3-C4 side shown in FIG. 2 in a position opposed to the fixed electrode 561. On the movable substrate 52, a movable extraction electrode 564 extending from the outer circumferential edge near the C-shape opening section of the movable electrode 562 toward the electric equipment surface 524 is provided. An extended distal end portion of the movable extraction electrode 564 forms a movable electrode pad 564P on the electric equipment surface 524 and is connected to the voltage control section 14.

As shown in FIG. 3, the movable reflection film 55 is provided to be opposed to the fixed reflection film 54 via the inter-reflection film gap G1 in the center of the movable surface 521A of the movable section 521. As the movable reflection film 55, a reflection film having the same configuration as the fixed reflection film 54 is used.

On the movable substrate 52, the movable conductive film 58 that covers the movable reflection film 55 is provided. The movable conductive film 58 is configured the same as the fixed conductive film 57. That is, the movable conductive film 58 is formed of a material having a refractive index larger than 1 and is formed in a thickness dimension twice or more as large as the thickness dimension of the movable reflection film 55. For example, in this embodiment, the thickness dimension of the movable reflection film 55 (e.g., an Ag alloy) is 30 nm and the thickness dimension of the movable conductive film 58 (e.g., ITO) is 200 nm. As explained above, the movable conductive film 58 functions as a capacitance measurement electrode for detecting a capacitance in conjunction with the fixed conductive film 57.

A movable capacitance electrode 581 is connected to the movable conductive film 58. The movable capacitance electrode 581 extends toward the electric equipment surface 524 through the C-shape opening section of the movable electrode 562. An extended distal end portion (a portion located on the side C3-C4 of the fixed substrate 51) of the movable capacitance electrode 581 forms a movable capacitance electrode pad 581P on the electric equipment surface 524 and is connected to the gap detecting section 15.

The retaining section 522 is a diaphragm that surrounds the movable section 521 and is formed smaller than the movable section 521 in a thickness dimension.

The retaining section 522 is more easily bent than the movable section 521. The retaining section 522 can displace, with slight electrostatic attraction, the movable section 521 to the fixed substrate 51 side. The movable section 521 has a thickness dimension and rigidity larger than those of the retaining section 522. Therefore, even when the retaining section 522 is drawn to the fixed substrate 51 side by electrostatic attraction, a shape change of the movable section 521 does not occur. Therefore, a bend of the movable reflection film 55 provided in the movable section 521 does not occur either. It is possible to always maintain the fixed reflection film 54 and the movable reflection film 55 in a parallel state.

In this embodiment, the retaining section 522 having a diaphragm shape is illustrated. However, the retaining section 522 is not limited to the diaphragm shape. For example, beam-like retaining sections arranged at an equal angle interval may be provided centering on the plane center point O.

As explained above, the substrate outer circumference section 525 is provided on the outer side of the retaining section 522 in the filter plan view. A surface of the substrate outer circumference section 525 opposed to the fixed substrate 51 includes the second joining section 523 opposed to the first joining section 513. The second joining film 532 is provided in the second joining section 523. As explained above, when the second joining film 532 is joined to the first joining film 531, the fixed substrate 51 and the movable substrate 52 are joined.

### Characteristics of the Variable Wavelength Interference Filter

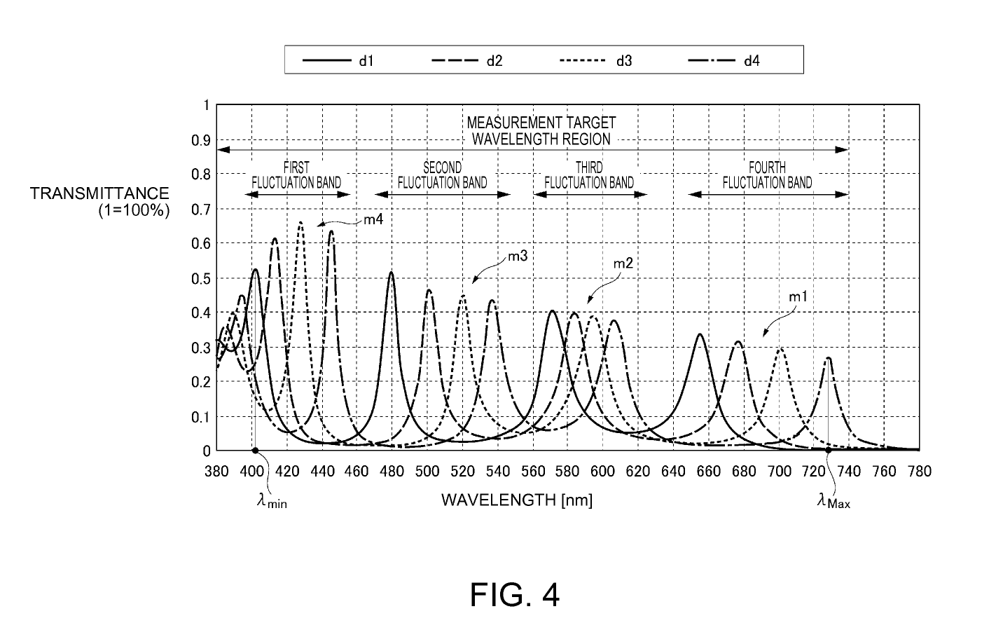

FIG. 4 is a graph showing an example of a spectrum of transmitted light of the variable wavelength interference filter 5. In FIG. 4, spectra of transmitted lights having four gap dimensions d1 to d4 (d1=500 nm, d2=550 nm, d3=600 nm, and d4=650 nm) are shown.

In general, when light is made incident on the variable wavelength interference filter 5, light having a predetermined wavelength based on the following Expression (1) is extracted.

mλ=2nd cos θ (1)

In Expression (1), λ represents wavelength of extracted light, θ represents incident angle of incident light, n represents refractive index of a medium between the reflection films 54 and 55, d represents distance (dimension of the gap G1) between the reflection films 54 and 55, and m represents order. Actually, the wavelength λ of the extracted light sometimes deviates from Expression (1) because of various factors such as the thicknesses and optical characteristics of the reflection films 54 and 55 and the substrates 51 and 52 that support the reflection films 54 and 55. For example, the spectra shown in FIG. 4 are obtained.

As shown in FIG. 4 and Expression (1), transmitted light of the variable wavelength interference filter 5 includes a plurality of peak wavelengths corresponding to orders m (m=1, 2, 3, 4, . . . ). As it is seen from Expression (1), when the dimension d of the gap G1 (hereinafter also referred to as gap dimension d) is fixed, the wavelength λ of the extracted light is larger as the order m is smaller. Conversely, the wavelength λ of the extracted light is smaller as the order m is larger.

In this embodiment, as shown in FIG. 4, a measurement target wavelength region is set to a visible light region (380 nm to 740 nm), the gap dimension d is sequentially changed, and four times of measurement (d=d1, d2, d3, d4: d1<d2<d3<d4) are carried out. In this case, as shown in FIG. 4, different four peak wavelengths corresponding to different four orders m1 to m4 (m1<m2<m3<m4) are included in the measurement target wavelength region.

A peak wavelength corresponding to the order m1 obtained when the dimension d of the gap G1 is set to the maximum dimension d4 (e.g., d4=650 nm) is a maximum wavelength λMax among measured wavelengths.

A peak wavelength corresponding to the order m4 obtained when the dimension d of the gap G1 is set to the minimum dimension d1 (e.g., d1=500 nm) is a minimum wavelength λmin among the measured wavelengths.

Fluctuation bands (wavelength bands) of peak wavelengths respectively corresponding to the orders m1, m2, m3, and m4 obtained when the gap dimension d is changed between d1 and d4 are represented as fourth fluctuation band, third fluctuation band, second fluctuation band, and first fluctuation band (see FIG. 4).

In the variable wavelength interference filter 5 in this embodiment, the number of times of sampling (the number of times of measurement), the order m set as a measurement target, an initial value of the gap dimension d, the thickness and the material of the conductive films 57 and 58 for setting the refractive index n of a medium between the reflection films 54 and 55, and the like are set as appropriate such that the peak wavelength corresponding to the order m4 obtained when the gap dimension d is set to d1 is the minimum wavelength λmin and the peak wavelength corresponding to the order m1 obtained when the gap dimension d is set to d4 is the maximum wavelength λMax as explained above. A driving width and a driving range of the gap dimension d are set such that the fluctuation bands do not overlap each other when the gap dimension d is changed.

### Configurations of the Light Separating Section and the Light Receiving Section

The light separating section 11 includes, as shown in FIG. 1, a plurality of dichroic mirrors 11A, 11B, and 11C as an example of the light separating element according to the invention.

The dichroic mirrors 11A, 11B, and 11C are configured to reflect lights in predetermined wavelength bands corresponding to fluctuation bands of wavelengths of lights corresponding to predetermined orders m and transmit the other lights. The plurality of dichroic mirrors 11A, 11B, and 11C are configured such that the predetermined wavelength bands respectively change to different bands.

The dichroic mirrors 11A, 11B, and 11C are arranged in series on an optical path of transmitted light of the variable wavelength interference filter 5. That is, the dichroic mirrors 11A, 11B, and 11C are arranged in order such that the transmitted light of the variable wavelength interference filter 5 is made incident on the dichroic mirror 11A and transmitted lights are respectively made incident on the other dichroic mirrors 11B and 11C.

The optical path of the transmitted light of the variable wavelength interference filter 5 is an optical path of the transmitted light on which a part of the transmitted light of the variable wavelength interference filter 5 is finally received by a detector 12D. The optical path coincides with an optical path of the transmitted light of the dichroic mirrors 11A, 11B, and 11C.

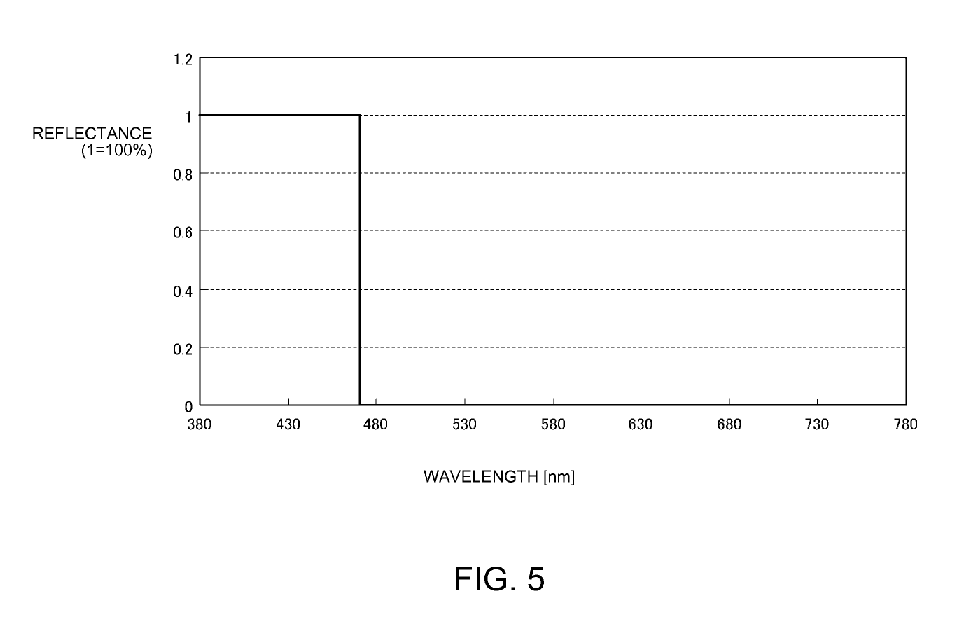

FIGS. 5 to 7 are respectively graphs showing optical characteristics of the dichroic mirrors 11A, 11B, and 11C. In the following explanation, wavelength bands of lights reflected by the dichroic mirrors 11A, 11B, and 11C, that is, the predetermined wavelength bands, are respectively referred to as first band, second band, and third band.

The dichroic mirror 11A is an example of the first light separating element according to the invention and is arranged on the variable wavelength interference filter 5 side. Transmitted light of the variable wavelength interference filter 5 is made incident on the dichroic mirror 11A. The dichroic mirror 11A reflects light corresponding to the order m4. As shown in FIG. 5, the dichroic mirror 11A reflects light in a wavelength band equal to or smaller than 470 nm, which is the first band, and transmits lights included in the other wavelength bands. The reflected light by the dichroic mirror 11A is also referred to as first reflected light L1 and the transmitted light by the dichroic mirror 11A is also referred to as first transmitted light L2. That is, the dichroic mirror 11A reflects light in the first fluctuation band and transmits lights in the second fluctuation band, the third fluctuation band, and the fourth fluctuation band.

The dichroic mirrors 11B and 11C are arranged in order on the opposite side of the variable wavelength interference filter 5 with respect to the dichroic mirror 11A.

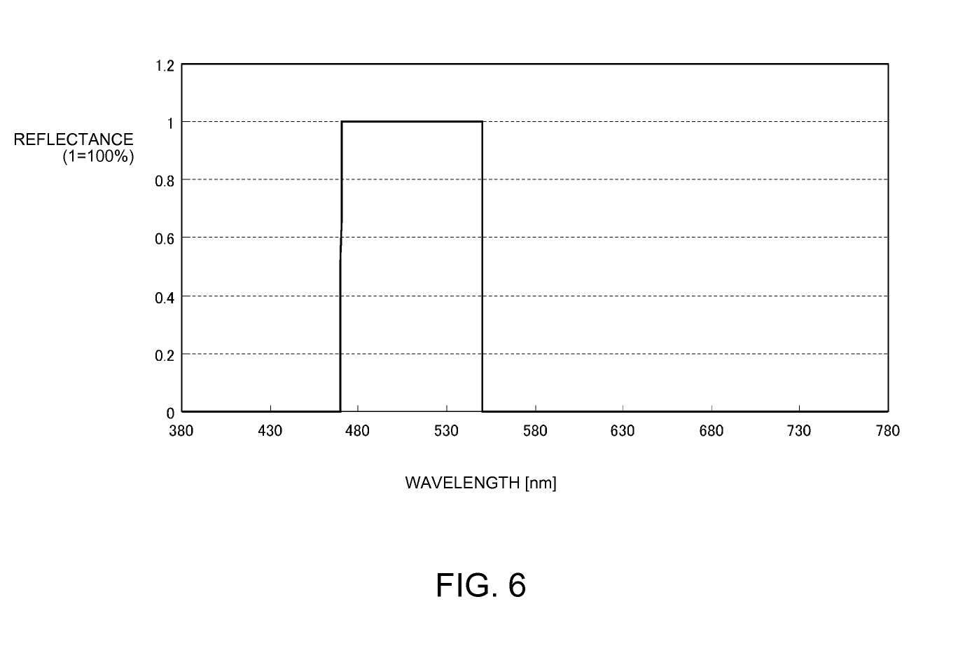

The dichroic mirror 11B is an example of the second light separating element according to the invention. The transmitted light of the dichroic mirror 11A is made incident on the dichroic mirror 11B. The dichroic mirror 11B reflects light corresponding to the order m3. As shown in FIG. 6, the dichroic mirror 11B reflects light in a wavelength band equal to or higher than 470 nm and equal to or lower than 550 nm, which is the second band. The reflected light of the dichroic mirror 11B is also referred to as second reflected light L3 and the transmitted light of the dichroic mirror 11B is also referred to as second transmitted light L4. That is, the dichroic mirror 11B reflects light in the second fluctuation band and transmits lights in the first fluctuation band, the third fluctuation band, and the fourth fluctuation band. Most of the light in the first fluctuation band is reflected by the dichroic mirror 11A. Therefore, a light amount of the light in the first fluctuation band made incident on the dichroic mirror 11B is extremely small and does not affect measurement accuracy.

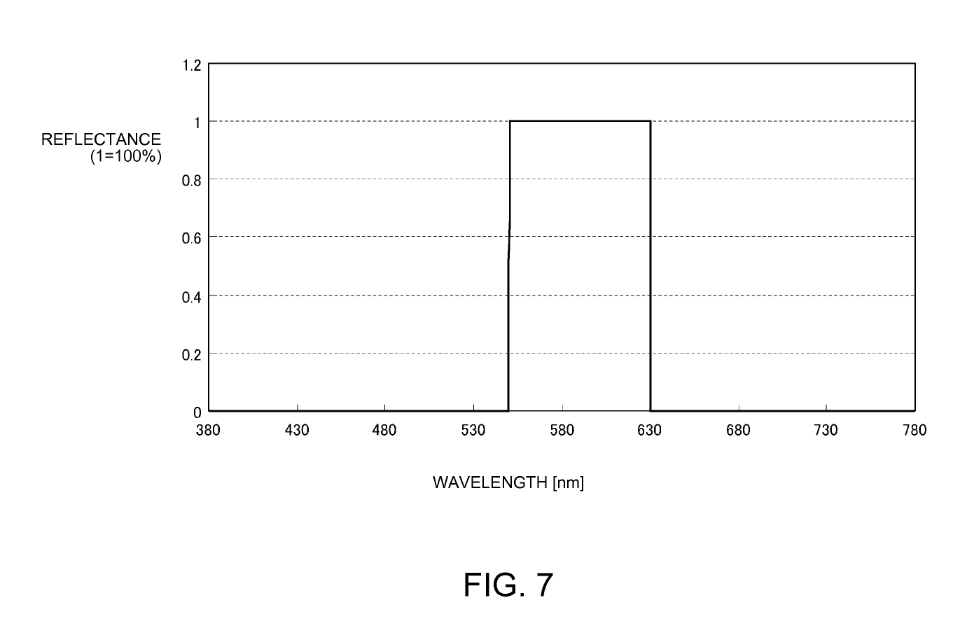

The dichroic mirror 11C reflects light corresponding to the order m2. As shown in FIG. 7, the dichroic mirror 11C reflects light in a wavelength band equal to or higher than 550 nm and equal to or lower than 630 nm, which is the third band, and transmits the other lights. The reflected light of the dichroic mirror 11C is also referred to as third reflected light L5 and the transmitted light of the dichroic mirror 11C is also referred to as third transmitted light L6. The third transmitted light L6 is light in a wavelength band equal to or higher than 630 nm. That is, the dichroic mirror 11C reflects light in the third fluctuation band and transmits lights in the first fluctuation band, the second fluctuation band, and the fourth fluctuation band. Most of the lights in the first fluctuation band and the second fluctuation band are respectively reflected by the dichroic mirrors 11A and 11B. Therefore, light amounts of the lights in the first and second fluctuation bands made incident on the dichroic mirror 11B is extremely small and does not affect measurement accuracy.

The light receiving section 12 includes detectors 12A, 12B, 12C, and 12D configured to respectively receive the first reflected light L1, the second reflected light L3, the third reflected light L5, and the third transmitted light L6 and output detection signals (currents) corresponding to light intensities of the received lights.

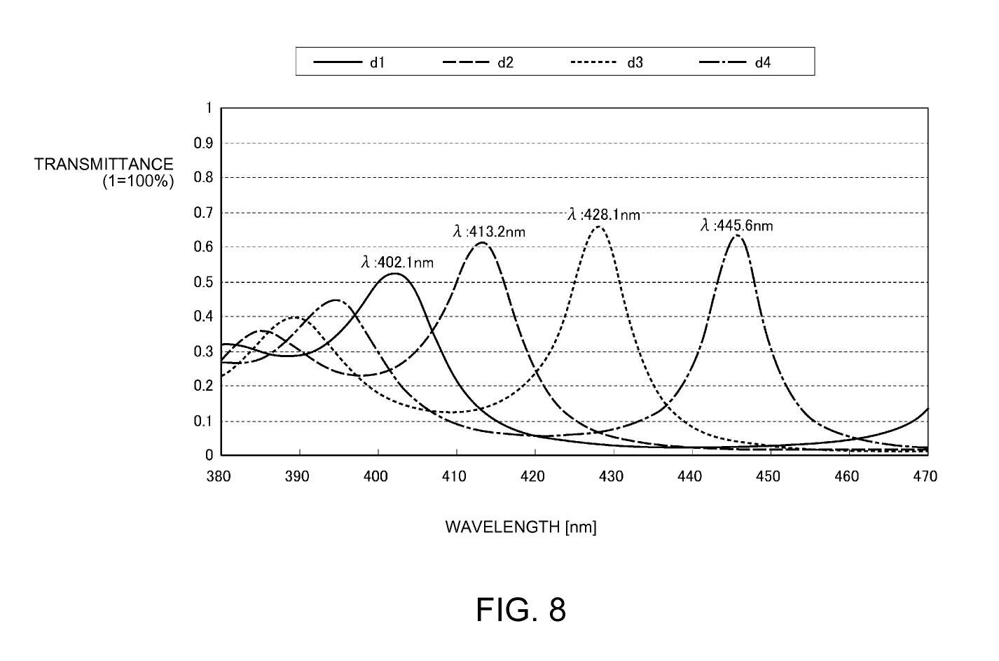

FIGS. 8 to 11 are graphs showing examples of lights respectively received by the detectors 12A, 12B, 12C, and 12D.

The detectors 12A, 12B, 12C, 12D are arranged on optical axes of the reflected lights of the dichroic mirrors 11A, 11B, and 11C. The detector 12D is arranged on an optical axis of the third transmitted light L6 of the dichroic mirror 11C.

The detector 12A is arranged on the optical axis of the first reflected light L1, which is the reflected light of the dichroic mirrors 11A, and receives the first reflected light L1. The first reflected light L1 shown in FIG. 8 is light corresponding to the order m4.

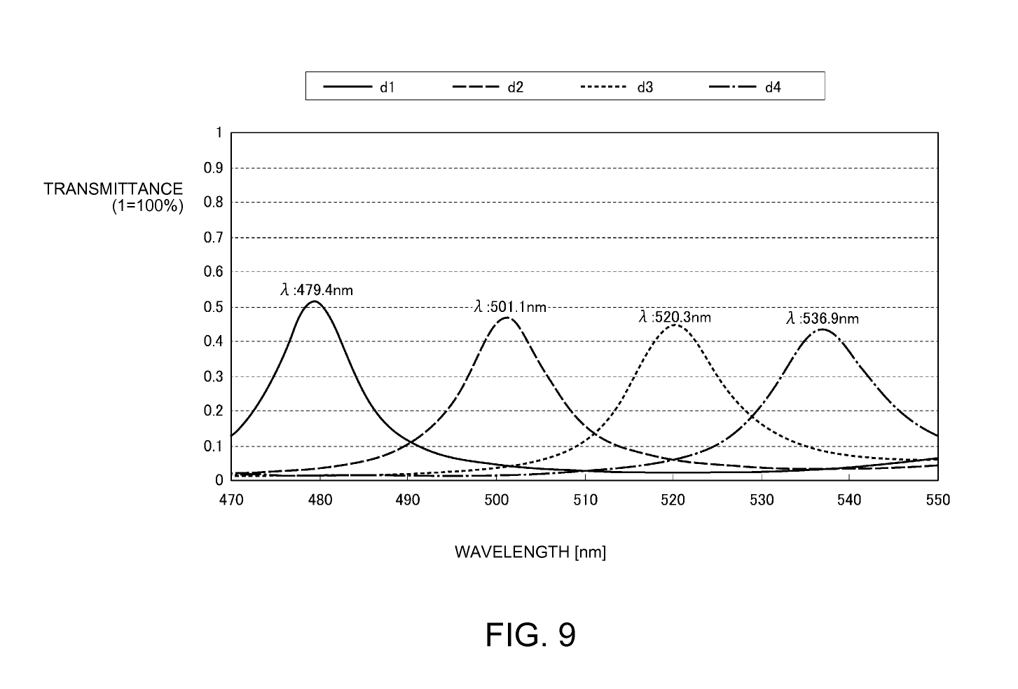

Similarly, the detector 12B is arranged on the optical axis of the second reflected light L3, which is the reflected light of the dichroic mirror 11B, and receives the second reflected light L3 (corresponding to the order m3 as shown in FIG. 9).

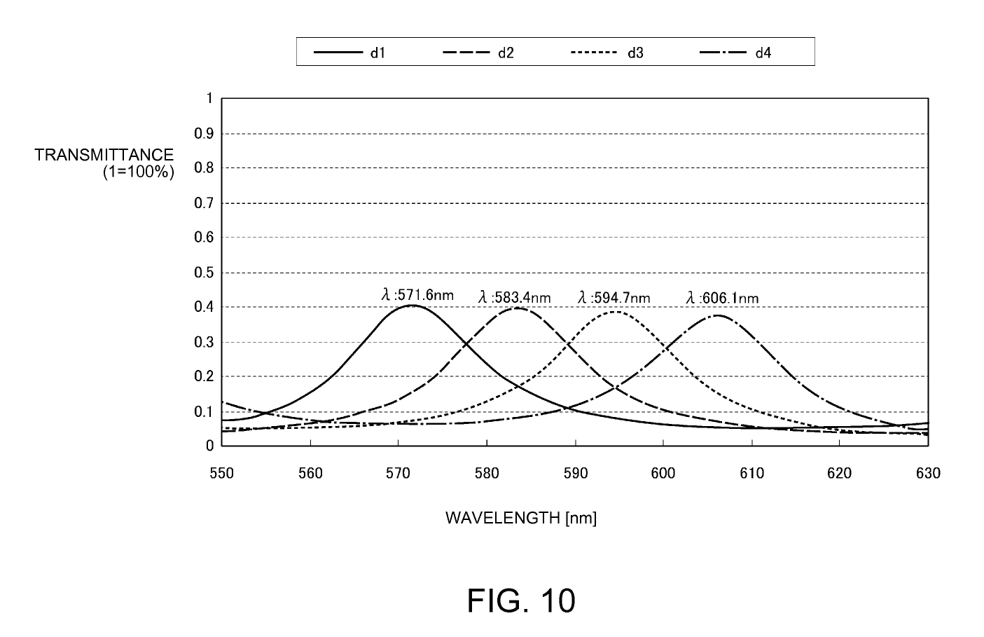

The detector 12C is arranged on the optical axis of the third reflected light L5, which is the reflected light of the dichroic mirror 11C, and receives the third reflected light L5 (corresponding to the order m2 as shown in FIG. 10).

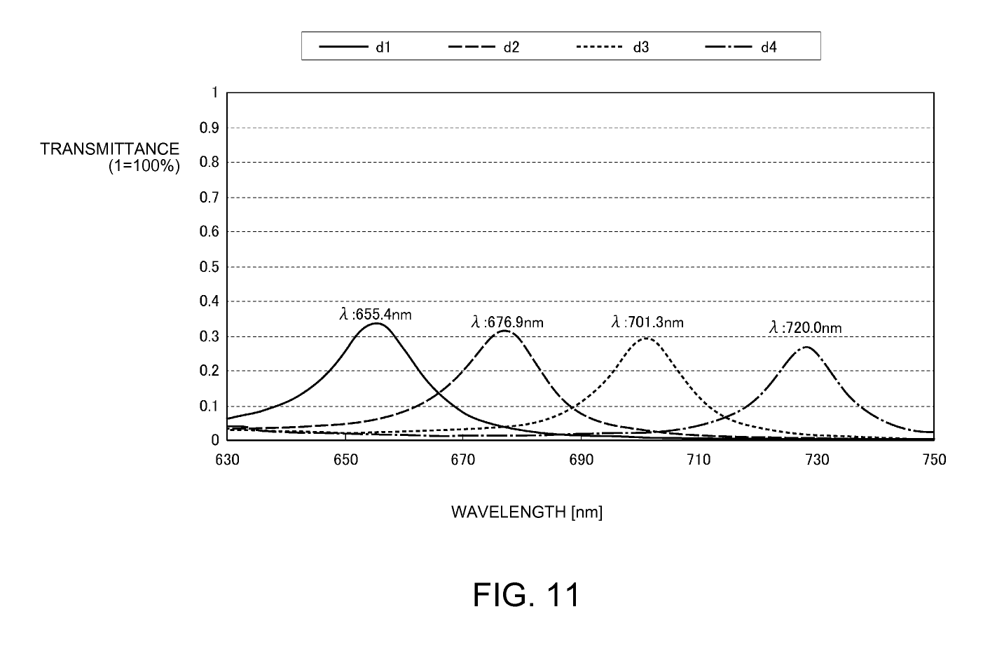

The detector 12D is arranged on the optical axis of the third transmitted light L6, which is the transmitted light of the dichroic mirror 11C, and receives the third transmitted light L6 (corresponding to the order m1 as shown in FIG. 11).

### Configurations of the Signal Converting Section, the Voltage Control Section, and the Gap Detecting Section

As shown in FIG. 1, the light receiving section 12, that is, the detectors 12A, 12B, 12C, and 12D are connected to the signal converting section 13. The signal converting section 13 converts a detection signal output from the light receiving section 12 into a voltage value (a detection voltage), after amplifying a voltage corresponding to the detection signal, converts the input detection voltage (an analog signal) into a digital signal, and outputs the digital signal to the control section 20.

The signal converting section 13 includes, although not shown in the figure, I-V converters configured to convert a detection signal into a voltage value, amplifiers configured to amplify a voltage (a detection voltage) corresponding to the detection signal, and A/D converters configured to convert an analog signal into a digital signal. The I-V converters, the amplifiers, and the A/D converters, and the like are individually provided for the detectors 12A, 12B, 12C, and 12D.

The voltage control section 14 is connected to the fixed extraction electrode 563A (the fixed electrode pad 563P) and the movable extraction electrode 564 (the movable electrode pad 564P) of the variable wavelength interference filter 5. The voltage control section 14 applies a voltage to the fixed electrode pad 563P and the movable electrode pad 564P on the basis of the control by the control section 20 to apply the voltage to the electrostatic actuator 56. Specifically, the voltage control section 14 connects the fixed electrode pad 563P to a ground circuit and sets the fixed electrode pad 563P to ground potential. On the other hand, the voltage control section 14 sets driving potential based on the control by the control section 20 for the movable electrode pad 564P. Consequently, electrostatic attraction is generated between the fixed electrode 561 and the movable electrode 562 of the electrostatic actuator 56. The movable section 521 is displaced to the fixed substrate 51 side. The dimension of the inter-reflection film gap G1 is set to a predetermined value.

The gap detecting section 15 is connected to the fixed conductive film 57 via the fixed capacitance electrode pad 572P of the variable wavelength interference filter 5 and connected to the movable conductive film 58 via the movable capacitance electrode pad 581P. The gap detecting section 15 applies a high-frequency voltage having an electrostatic capacitance detection amount, which does not affect driving, between the conductive films 57 and 58, detects capacitance between the conductive films 57 and 58, and outputs a detection signal to the control section 20. The gap detecting section 15 may calculate, on the basis of a detection signal, a dimension of the gap G2 based on the capacitance, further calculate the gap dimension d of the inter-reflection gap from the thickness dimension of the conductive films 57 and 58, and then output a signal corresponding to the calculated gap dimension d to the control section 20.

### Configuration of the Control Section

The control section 20 is configured by combining a CPU, a memory, and the like and controls the entire operation of the spectrometry device 1. The control section 20 includes, as shown in FIG. 1, a filter driving section 21, a light-amount acquiring section 22, and a spectrometry section 23.

The control section 20 includes a storing section 30 configured to store various kinds of data. The storing section 30 stores V-λ data for controlling the electrostatic actuator 56 and various parameters such as the thickness of the conductive films 57 and 58.

In the V-λ data, a peak wavelength of light transmitted through the variable wavelength interference filter 5 with respect to a voltage applied to the electrostatic actuator 56 is recorded.

The filter driving section 21 sets a target wavelength of light extracted by the variable wavelength interference filter 5 and reads a target voltage value corresponding to the set target wavelength from the V-λ data stored in the storing section 30. The filter driving section 21 outputs, to the voltage control section 14, a control signal to the effect that the read target voltage value is applied. Consequently, the voltage control section 14 applies a voltage having the target voltage value to the electrostatic actuator 56.

The light-amount acquiring section 22 acquires, on the basis of the light amount acquired by the light receiving section 12, a light amount of the light having the target wavelength transmitted through the variable wavelength interference filter 5.

The spectrometry section 23 measures a spectral characteristic of measurement target light on the basis of the light amount acquired by the light-amount acquiring section 22.

Examples of a spectrometry method in the spectrometry section 23 include a method of measuring a spectral spectrum using, as a light amount of the measurement target wavelength, a light amount detected by the light receiving section 12 for the measurement target wavelength and a method of estimating a spectral spectrum on the basis of light amounts of a plurality of measurement target wavelengths.

As the method of estimating a spectral spectrum, for example, a measurement spectrum matrix in which light amounts corresponding to a plurality of measurement target wavelengths are set as matrix elements. A predetermined conversion matrix is caused to act on the measurement spectrum matrix to estimate a spectral spectrum of measurement target light. In this case, a plurality of sample lights, spectral spectra of which are known, are measured by the spectrometry device 1. A conversion matrix is set to minimize a deviation between a matrix obtained by causing the conversion matrix to act on a measurement spectrum matrix generated on the basis of a light amount obtained by the measurement and the known spectral spectra.

### Spectrometry Processing in the Spectrometry Device

Spectrometry processing in the spectrometry device 1 in this embodiment is explained.

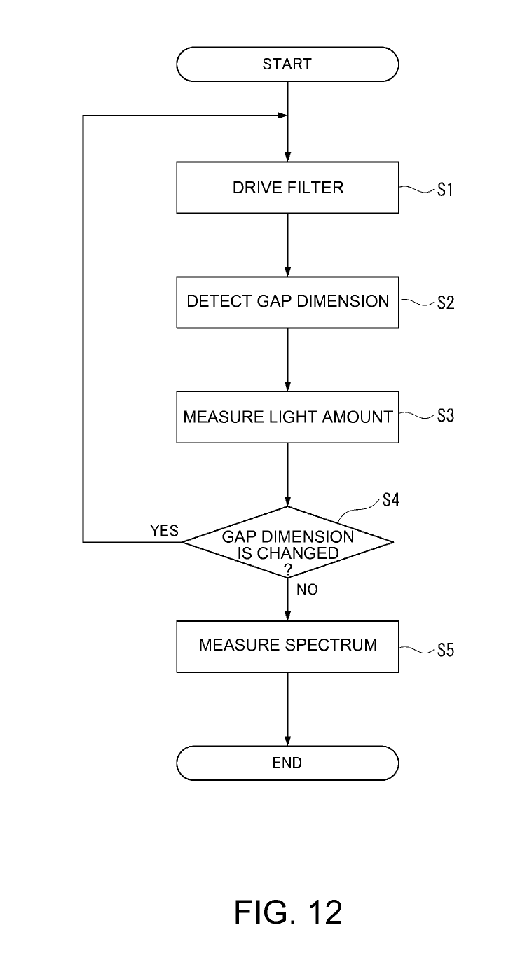

FIG. 12 is a flowchart showing an example of the spectrometry processing in the spectrometry device 1.

In the spectrometry processing in this embodiment, the spectrometry processing is applied to a plurality of the predetermined gap dimensions d to measure a spectral spectrum of measurement target light with respect to a predetermined measurement target wavelength region (e.g., 380 nm to 720 nm). In this case, lights corresponding to a plurality of orders m are simultaneously measured in one gap dimension d.

In the following explanation, as an example of the spectrometry processing, the spectrometry device 1 sequentially switches the gap dimension d to d1 to d4 (d1=500 nm, d2=550 nm, d3=600 nm, and d4=650 nm) to perform the spectrometry. In the gap dimensions d, the spectrometry device 1 simultaneously measures lights corresponding to the four orders m (m1, m2, m3, and m4).

First, as shown in FIG. 12, the spectrometry device 1 sets the gap dimension d of the variable wavelength interference filter 5 to d1 (step S1).

The filter driving section 21 of the control section 20 outputs, to the voltage control section 14 of the optical module 10, a control signal for setting the variable wavelength interference filter 5 to the gap dimension d4=650 nm. Consequently, the voltage control section 14 applies a voltage to the electrostatic actuator 56 of the variable wavelength interference filter 5 on the basis of the control signal output from the control section 20. Consequently, the gap dimension d of the variable wavelength interference filter 5 is set to d1.

Subsequently, the spectrometry device 1 measures the gap dimension d of the variable wavelength interference filter 5 (step S2).

The spectrometry section 23 calculates a dimension of the gap G2 on the basis of a detection signal output from the gap detecting section 15 and further calculates the gap dimension d of the inter-reflection film gap G1 on the basis of the thickness of the conductive films 57 and 58 stored in the storing section 30. The spectrometry section 23 stores the calculated gap dimension d in a storage unit such as a memory. The filter driving section 21 may carry out feedback processing for controlling the applied voltage to the electrostatic actuator 56 on the basis of the calculated gap dimension d. In this case, it is possible to accurately set the gap dimension d to a desired value.

Subsequently, the spectrometry device 1 measures a light amount obtained when the gap dimension d is set to the gap dimension d1 (step S3).

The variable wavelength interference filter 5 transmits, for example, light corresponding to d4 shown in FIG. 4 from incident measurement target light according to multiple interference by the reflection films 54 and 55. The transmitted light includes peak wavelength lights (interference lights) in the first, second, third, and fourth fluctuation bands respectively corresponding to the orders m1, m2, m3, and m4. Therefore, first, the transmitted light of the variable wavelength interference filter 5 is made incident on the dichroic mirror 11A. Then, the light including the peak wavelength in the first fluctuation band corresponding to the order m4 is reflected as the first reflected light L1 and the other lights are transmitted. The first reflected light L1 reflected by the dichroic mirror 11A is received by the detector 12A.

The light transmitted through the dichroic mirror 11A is made incident on the dichroic mirror 11B. Then, the light including the peak wavelength in the second fluctuation band corresponding to the order m3 is reflected as the second reflected light L3 and the other lights are transmitted. The second reflected light L3 reflected by the dichroic mirror 11B is received by the detector 12B.

The light transmitted through the dichroic mirror 11B is made incident on the dichroic mirror 11C. Then, the light including the peak wavelength in the third fluctuation band corresponding to the order m2 is reflected as the third reflected light L5 and the other lights are transmitted as the third transmitted light L6. The third reflected light L5 reflected by the dichroic mirror 11C is received by the detector 12C. The third transmitted light L6 transmitted by the dichroic mirror 11C is received by the detector 12D.

The detectors 12A, 12B, 12C, and 12D output detection signals corresponding to light reception amounts to the control section 20 via the signal converting section 13.

The light-amount acquiring section 22 of the control section 20 sequentially acquires light amounts of the light received by the detectors 12A, 12B, 12C, and 12D and stores the light amounts in the storing unit such as the memory in association with the gap dimension d.

Subsequently, the spectrometry device 1 determines whether light amounts are acquired in all the measurement target gap dimensions d, that is, whether the gap dimension is changed (step S4).

In this case, the spectrometry device 1 needs to acquire light amounts in the gap dimensions other than the gap dimension d1 (determines YES in step S4). Therefore, the spectrometry device 1 returns to step S1 and performs the same processing concerning the other gap dimensions d2, d3, and d4.

Subsequently, when the spectrometry device 1 acquires light amounts concerning all the gap dimensions d1, d2, d3, and d4 (determines NO in step S4), the spectrometry section 23 measures spectral characteristics of the measurement target light on the basis of the light amounts stored in the storing unit (step S5).

As shown in FIG. 8, the first reflected light L1 corresponding to the order m4 includes peak wavelengths higher in order than the order m4. In such a case, the spectrometry device 1 estimates a peak wavelength and a light amount corresponding to the order m4 from a measurement result of a light amount of the first reflected light L1 to estimate a spectral spectrum according to the method of estimating a spectral spectrum explained above.

A band-pass filter that transmits only light having a wavelength corresponding to the first fluctuation band may be arranged between the dichroic mirror 11A and the detector 12A. In this case, light received by the detector 12A changes to interference light of the order m4. Therefore, it is unnecessary to estimate a spectral spectrum. It is possible to improve measurement accuracy of a spectral spectrum. Further, it is possible to reduce a processing load on the control section 20.

### Action and Effect of the Spectrometry Device

The optical module 10 included in the spectrometry device 1 in this embodiment includes the plurality of dichroic mirrors 11A, 11B, and 11C arranged in series on the optical path of the transmitted light of the variable wavelength interference filter 5. The plurality of dichroic mirrors 11A, 11B, and 11C are configured to reflect lights in the predetermined wavelength bands corresponding to the fluctuation bands of the wavelengths of the lights corresponding to the predetermined orders m in the incident light and transmit the other lights. The plurality of dichroic mirrors 11A, 11B, and 11C are configured such that the predetermined wavelength bands are respectively changed to different bands.

With such a configuration, it is possible to simultaneously acquire, in one measurement, light amount values of the peak wavelengths corresponding to the plurality of orders m (in this embodiment, light amount values in sixteen wavelengths corresponding to the four orders m). Consequently, whereas sixteen times of measurement need to be performed when interference light of one order (e.g., first order) is used, only four times of measurement have to be performed in this embodiment. Therefore, the spectrometry device 1 can substantially reduce a measurement time.

Even if band-pass filters are arranged in parallel to the transmitted light of the variable wavelength interference filter 5, it is possible to simultaneously measure the lights corresponding to the plurality of orders m. However, in such a configuration, the lights corresponding to the orders m are extracted from a part of the transmitted light of the variable wavelength interference filter 5. Therefore, since light amounts of lights transmitted through the band-pass filters decrease, a light reception amount in the light receiving section also decreases and light reception efficiency is deteriorated. In this case, if the measurement is performed in a short time, a light reception amount sufficient for securing spectral accuracy cannot be obtained and highly accurate spectrometry cannot be carried out. Therefore, in order to carry out the highly accurate spectrometry, it is conceivable to increase the size of the variable wavelength interference filter and increase the light reception amount. However, the optical module and the spectroscopy device are also increased in size according to the increase in the size of the variable wavelength interference filter. Further, a bend of the substrates of the variable wavelength interference filter, a bend of the reflection films, and the like also tend to occur and spectral accuracy is deteriorated.

On the other hand, in the optical module 10 in this embodiment, the plurality of dichroic mirrors 11A, 11B, and 11C are arranged in series on the optical path of the transmitted light of the variable wavelength interference filter 5. That is, the plurality of dichroic mirrors 11A, 11B, and 11C are arranged such that the transmitted light of the variable wavelength interference filter 5 is made incident on the dichroic mirror 11A, the first transmitted light L2 of the dichroic mirror 11A is made incident on the dichroic mirror 11B, and the second transmitted light L4 of the dichroic mirror 11B is made incident on the dichroic mirror 11C.

With such a configuration, the dichroic mirror 11A can be arranged such that the entire transmitted lights of the variable wavelength interference filter 5 are made incident on the dichroic mirrors 11A, 11B, and 11C. The first transmitted light L2 of the dichroic mirror 11A, which transmits a part of the transmitted light of the variable wavelength interference filter 5, is made incident on the dichroic mirror 11B, separated as the second reflected light L3, and received by the detector 12B. The dichroic mirror 11C is configured the same as the dichroic mirror 11B.

Consequently, light reception amounts in the detectors 12A, 12B, 12C, and 12D increase compared with the configuration in the past explained above. It is possible to obtain high spectral accuracy and attain a substantial reduction in a measurement time.

In this embodiment, the dichroic mirrors 11B and 11C respectively reflect lights including peak wavelengths corresponding to one order m.

With such a configuration, the second reflected light L3 and the third reflected light L5, which are the reflected lights from the dichroic mirrors 11B and 11C, respectively include peak wavelengths corresponding to the order m3 and the order m2 and do not include lights corresponding to the other orders m. Consequently, light reception results by the detectors 12B and 12C are respectively light amount values of the peak wavelengths corresponding to the orders m3 and m2. Therefore, it is unnecessary to estimate a spectrum. It is possible to highly accurately and easily measure a spectral spectrum.

In this embodiment, the variable wavelength interference filter 5 includes the fixed conductive film 57 and the movable conductive film 58 arranged between the reflection films 54 and 55.

The conductive films 57 and 58 can increase an optical path length of light transmitted between the reflection films 54 and 55 and can increase a value corresponding to the refractive index n of the medium between the reflection films 54 and 55 in Expression (1). Consequently, it is possible to include a peak wavelength corresponding to the high order m in the measurement target wavelength region without increasing the distance between the reflection films 54 and 55.

The conductive films 57 and 58 respectively cover the reflection films 54 and 55. Therefore, the conductive films 57 and 58 can function as protection films and suppress deterioration of the reflection films 54 and 55.

Further, when the measurement is carried out using high-order peak wavelengths, compared with using low-order peak wavelengths, a larger number of peak wavelengths can be included in the measurement target wavelength region. Therefore, by using dichroic mirrors corresponding to the peak wavelengths, it is possible to simultaneously measure a larger number of peak wavelengths.

Further, it is also possible to attain improvement of measurement accuracy by carrying out the measurement using the high-order peak wavelengths.

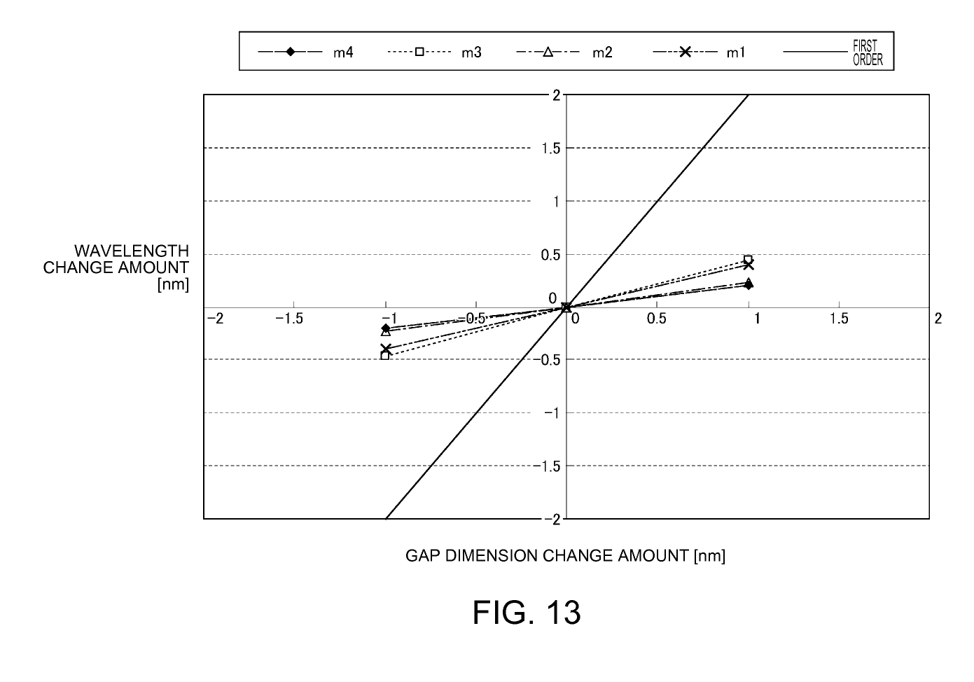

FIG. 13 is a graph showing a change amount of the wavelength λ with respect to a change amount of the gap dimension d concerning first-order (m=1) interference light and interference lights corresponding to second or higher orders. As shown in FIG. 13, a wavelength change with respect to a change in the gap dimension d is smaller in the high-order interference lights than in the first-order interference light.

Therefore, as explained above, by using the high-order peak wavelengths for the measurement, it is possible to suppress the wavelength change with respect to fluctuation in the gap dimension d. Consequently, even when deviation occurs from a desired gap dimension d during driving of the variable wavelength interference filter 5, it is possible to suppress deviation of a wavelength and improve measurement accuracy.

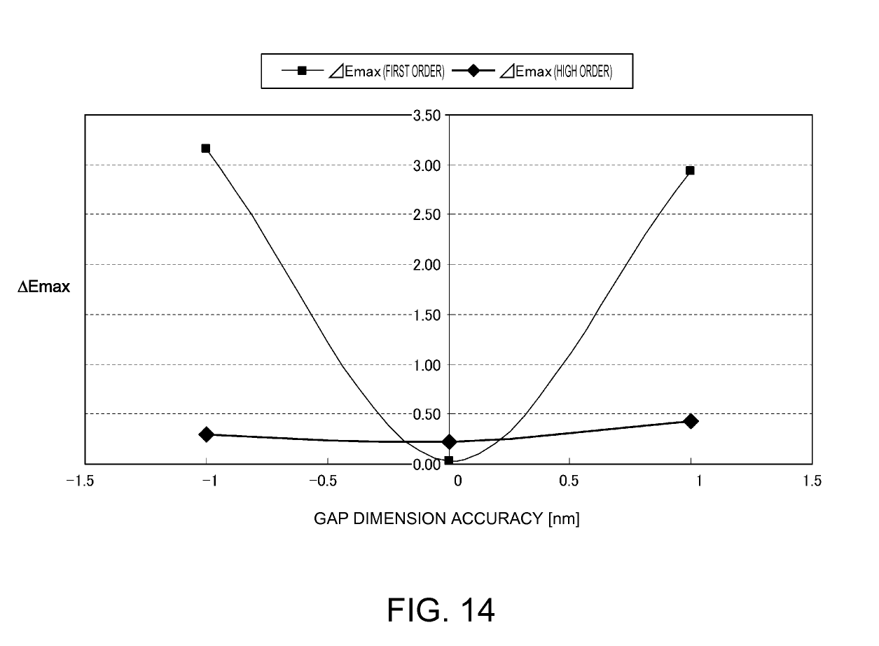

FIG. 14 is a graph showing a relation between accuracy of the gap dimension d and a color difference ΔE in colorimetric processing performed using first-order interference light and high-order interference light. In an example shown in FIG. 14, measurement is performed for five hundred colors (wavelengths). As shown in FIG. 14, the color difference can be further reduced when the colorimetric processing is performed by the optical module 10 in this embodiment using the high-order interference light than when the colorimetric processing is performed using the first-order interference light. Therefore, when the optical module 10 in this embodiment is used, even when deviation occurs from the desired gap dimension d, it is possible to improve colorimetric accuracy.

The optical module 10 in this embodiment detects, with the gap detecting section 15, a capacitance between the fixed conductive film 57 and the movable conductive film 58 and calculates the gap dimension d from the capacitance. The spectrometry device 1 controls the gap dimension d of the variable wavelength interference filter 5 on the basis of a detection result of the gap dimension d.

In this embodiment, as explained above, since the measurement is carried out using the high-order peak wavelengths, it is necessary to set the gap dimension d of the inter-reflection film gap G1 large. When a capacitance detection electrode is provided in a position at the same height as the reflection films 54 and 55, since a gap interval is too large, it is likely that gap detection accuracy is deteriorated. On the other hand, in this embodiment, the gap dimension between the conductive films 57 and 58 that cover the reflection films 54 and 55 is detected. In this case, since a capacitance in the dimension of the gap G2 smaller than the inter-reflection film gap G1 is detected, it is possible to attain improvement of gap detection accuracy.

### Other Embodiments

The invention is not limited to the embodiment explained above. Modifications, improvements, and the like within a range in which the object of the invention can be attained are included in the invention.

For example, in the explanation in the embodiment, in the dichroic mirrors 11A, 11B, and 11C, the reflectance of light in a predetermined band is 1 and the reflectance of light in the other bands is 0 (transmittance is 1). However, the dichroic mirrors are not limited to this. Actually, in the dichroic mirrors, the transmittance in the bands other than the predetermined band is smaller than 1. The dichroic mirrors reflect a part of wavelengths in the bands other than the predetermined band. That is, a part of light having a wavelength desired to be transmitted by the dichroic mirrors is reflected and a part of light having a wavelength desired to be reflected by the dichroic mirrors is transmitted.

In this case, in the optical path of the transmitted light of the variable wavelength interference filter 5, the dichroic mirrors are arranged in order from the dichroic mirror having highest optical characteristic. That is, the dichroic mirrors are arranged in order from the dichroic mirror having lowest transmittance of light in a reflection target band and having lowest reflectance of light in a band other than the reflection target band (light in a transmission target band).

Consequently, it is possible to suppress the light in the band other than the predetermined band (the light in the transmission target band) from being included in reflected lights of the dichroic mirrors and improve measurement accuracy. Since the light in the band other than the predetermined band (the light in the transmission target band) is reflected by the dichroic mirror arranged on the variable wavelength interference filter 5 side, it is possible to suppress a decrease in a light reception amount in the light receiving section 12.

In the embodiment, the configuration is illustrated in which the optical path including transmitted light of the variable wavelength interference filter 5 and the dichroic mirrors 11A, 11B, and 11C is a straight line. However, the optical path is not limited to this. That is, the transmitted light may be a curved line curved by a mirror or the like. In this case, as in the embodiment, a plurality of dichroic mirrors only have to be arranged along the optical path of the transmitted light.

In this embodiment, the reflected light of the dichroic mirrors is directly received by the detector. However, the reception of the reflected light is not limited to this. For example, a cut filter for removing lights in wavelength bands other than a desired wavelength band may be provided between the dichroic mirrors and the detector. For example, a dichroic mirror for further separating the reflected light of the dichroic mirrors may be provided.

In the embodiment, the measurement target wavelength region, the gap dimension d, the plurality of orders m, the fluctuation bands in the plurality of orders m, the bands of the reflection target wavelength of the dichroic mirrors, and the like are explained using the specific numerical values. However, these are not limited to the numerical values.

For example, the measurement target wavelength region is explained as 380 nm to 720 nm. However, the measurement target wavelength region is not limited to this numerical value and may be set to include a wavelength region equal to or smaller than 380 nm and a wavelength region equal to or larger than 720 nm. In this case, an initial value of the gap dimension d of the variable wavelength interference filter 5, the thickness of the conductive films 57 and 58, and the like only have to be set as appropriate such that the measurement target fluctuation bands in the plurality of orders m are included in the measurement target wavelength region. The reflection target wavelength bands of the dichroic mirrors only have to be set as appropriate according to the initial value of the gap dimension d, the thickens of the conductive films 57 and 58, and the like.

In the embodiment, the dichroic mirrors 11B and 11C are configured to reflect the light including the peak wavelength corresponding to one order among the plurality of the measurement target orders m. However, the dichroic mirrors 11B and 11C are not limited to the configuration. For example, like the dichroic mirror 11A shown in FIG. 8, the dichroic mirrors 11B and 11C may be configured to reflect the light including the peak wavelengths corresponding to the plurality of orders m. In this case, it is possible to accurately measure light amounts with respect to the peak wavelengths by estimating a spectral spectrum from a measurement result.

In the embodiment, the dichroic mirrors 11A, 11B, and 11C are configured such that the reflection target wavelength bands are respectively different. However, the dichroic mirrors 11A, 11B, and 11C are not limited to this configuration. For example, the dichroic mirrors 11A, 11B, and 11C may be configured such that parts of the bands overlap. For example, even if parts of the reflection bands of the dichroic mirror 11A and the dichroic mirror 11B overlap, light in the overlapping bands is reflected by the dichroic mirror 11A and received by the detector 12A.

In the embodiment, the configuration is illustrated in which, in the dichroic mirrors 11A, 11B, and 11C, the light of the measurement target order is included in the reflected light. However, the dichroic mirrors 11A, 11B, and 11C are not limited to this configuration. For example, the light of the measurement target order may be included in the transmitted light. In this case, transmitted light may be received by the detector and reflected light may be further separated by the light separating element.

In the embodiment, the dichroic mirror is illustrated as the light separating element. However, the light separating element is not limited to the dichroic mirror. As the light separating element, an optical element having a function same as the function of the dichroic mirror such as a dichroic prism may be used. The dichroic mirror separates the light transmitted through the variable wavelength interference filter 5 into the reflected light and the transmitted light. However, the light may be separated into three or more optical paths corresponding to wavelength bands (e.g., a red wavelength region is reflected in a first direction, a blue wavelength region is reflected in a second direction, and a green wavelength region is transmitted) using a cross dichroic prism or the like.

In the embodiment, the configuration is illustrated in which the conductive films 57 and 58 are used as the capacitance measurement electrode. However, the capacitance measurement electrode is not limited to the conductive films 57 and 58. The capacitance measurement electrode may be separately provided. The configuration of the variable wavelength interference filter 5 can be simplified by using the conductive films 57 and 58 as the protection films and the capacitance measurement electrode as in the embodiment.

In the embodiment, the configuration is illustrated in which the fixed conductive film 57 is directly provided on the fixed reflection film 54. However, the fixed conductive film 57 and the fixed reflection film 54 are not limited to this configuration. Another functional film such as a dielectric multilayer film may be provided between the fixed reflection film 54 and the fixed conductive film 57. The same applies to the movable reflection film 55 and the movable conduction film 58.

In the embodiment, the configuration is illustrated in which the size of the inter-reflection film gap G1 is changed by electrostatic attraction by applying a voltage to the fixed electrode 561 and the movable electrode 562 in the variable wavelength interference filter 5. However, the variable wavelength interference filter 5 is not limited to this configuration. For example, as an actuator configured to change the inter-reflection film gap G1, a dielectric actuator may be used in which a first dielectric coil is arranged instead of the fixed electrode 561 and a second dielectric coil or a permanent magnet is arranged instead of the movable electrode 562.

Further, a piezoelectric actuator may be used instead of the electrostatic actuator 56. In this case, for example, a lower electrode layer, a piezoelectric film, and an upper electrode layer are laminated and arranged in the retaining section 522. A voltage applied between the lower electrode layer and the upper electrode layer is varied as an input value. Consequently, it is possible to expand and contract the piezoelectric film to bend the retaining section 522.

In the embodiment, the variable wavelength interference filter 5 configured to be capable of changing the inter-reflection film gap G1 is illustrated. However, the variable wavelength interference filter 5 is not limited to this configuration. The variable wavelength interference filter 5 may be an interference filter in which the size of the inter-reflection film gap G1 is fixed.

In the embodiment, the variable wavelength interference filter 5 including the rectangular substrates 51 and 52 is illustrated. However, the shape of the substrates 51 and 52 is not limited to the rectangular shape. For example, the shape of the substrates 51 and 52 in the filter plan view may be various polygonal shapes other than the rectangular shape or may be a circular shape or an elliptical shape. The side surfaces of the substrates 51 and 52 may include curved surfaces.

In the embodiment, as the variable wavelength interference filter 5, the configuration is illustrated including the pair of substrates 51 and 52 and the pair of reflection films 54 and 55 respectively provided on the substrates 51 and 52. However, the variable wavelength interference filter 5 is not limited to this configuration. For example, the movable substrate 52 does not have to be provided. In this case, for example, a first reflection film, a gap spacer, and a second reflection film are laminated and formed on one surface of a substrate (a fixed substrate). The first reflection film and the second reflection film are opposed to each other via a gap. In this configuration, the variable wavelength interference filter 5 includes one substrate. It is possible to further reduce the light separating elements in thickness.

In the embodiment, the optical module 10 may include a housing configured to house the variable wavelength interference filter 5. In such a configuration, the inside of the housing that houses the variable wavelength interference filter 5 can be maintained in a vacuum state (or a decompressed state). Consequently, it is possible to highly accurately drive the variable wavelength interference filter 5. It is possible to suppress deterioration of the members included in the variable wavelength interference filter 5 such as the reflection films.

As the electronic device according to the invention, in this embodiment, the spectrometry device 1 is illustrated. Besides, the optical module and the electronic device according to the invention can be applied to various fields.

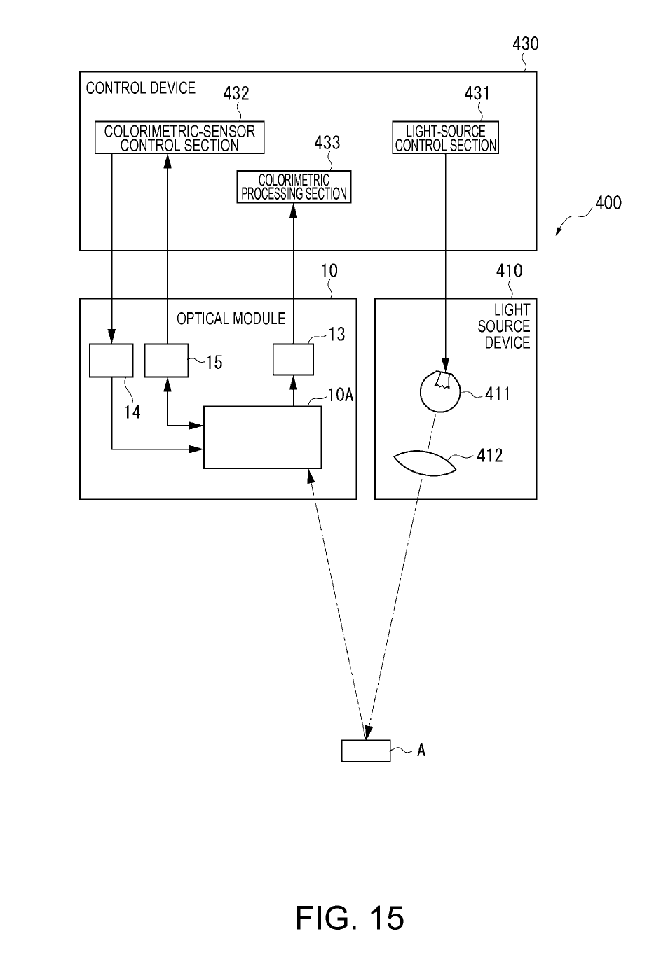

For example, as shown in FIG. 15, the electronic device according to the invention can be applied to a colorimetric device for measuring a color.

FIG. 15 is a block diagram showing an example of a colorimetric device 400 including a variable wavelength interference filter.

The colorimetric device 400 includes, as shown in FIG. 15, a light source device 410 configured to emit light to an inspection target A, the optical module 10 functioning as a calorimetric sensor, and a control device 430 (a processing section) configured to control the entire operation of the colorimetric device 400. The colorimetric device 400 is a device that reflects the light emitted from the light source device 410 on the inspection target A, receives the reflected inspection target light in the optical module 10, and analyzes and measures chromaticity of the inspection target light, that is, a color of the inspection target A on the basis of a detection signal output from the optical module 10.

The optical module 10 has a configuration same as the configuration explained in the embodiment. Therefore, explanation of the optical module 10 is omitted. The optical module 10 is shown in the figure in a simplified form.

The light source device 410 includes a light source 411, a plurality of lenses 412 (only one is shown in FIG. 15) and emits, for example, reference light (e.g., white light) to the inspection target A. The plurality of lenses 412 may include a collimator lens. In this case, the light source device 410 changes the reference light emitted from the light source 411 into parallel light with the collimator lens and emits the parallel light to the inspection target A from a not-shown projection lens. In this embodiment, the colorimetric device 400 including the light source device 410 is illustrated. However, for example, when the inspection target A is a light-emitting member such as a liquid crystal panel, the light source device 410 does not have to be provided.

The control device 430 controls the entire operation of the colorimetric device 400.

As the control device 430, for example, a general-purpose personal computer, a portable information terminal, a colorimetry-dedicated computer, and the like can be used. The control device 430 includes, as shown in FIG. 15, a light-source control section 431, a colorimetric-sensor control section 432, and a calorimetric processing section 433.

The light-source control section 431 is connected to the light source device 410. The light-source control section 431 outputs a predetermined control signal to the light source device 410 on the basis of, for example, a setting input of a user and causes the light source device 410 to emit white light having predetermined brightness.

The colorimetric-sensor control section 432 is connected to the optical module 10. The colorimetric-sensor control section 432 sets, on the basis of, for example, a setting input of the user, a wavelength of light to be received by the optical module 10 and outputs, to the optical module 10, a control signal to the effect that a light reception amount of the light having the wavelength is to be detected. Consequently, the voltage control section 14 of the optical module 10 applies a voltage to the electrostatic actuator 56 on the basis of the control signal and causes the electrostatic actuator 56 to drive the variable wavelength interference filter 5.

The colorimetric processing section 433 is an example of the control section according to the invention. The colorimetric processing section 433 analyzes chromaticity of the inspection target A from a light reception amount detected by the light receiving section 12. As in the embodiment, the colorimetry processing section 433 may estimate a spectral spectrum S using, as a measurement spectrum D, a light amount obtained by the light receiving section 12 to analyze the chromaticity of the inspection target A. As a method of estimating a spectral spectrum, the method explained in the embodiment only has to be used.

Other examples of the electronic device according to the invention include a light-based system for detecting presence of a specific substance. Examples of such a system include a vehicle-mounted gas leak detector that adopts a spectral measurement system for measuring a spectral spectrum using a variable wavelength interference filter and detects a specific gas at high sensitivity and a gas detecting device such as a photoacoustic rare gas detector for an expiration test.

An example of such a gas detecting device is explained below with reference to the drawings.

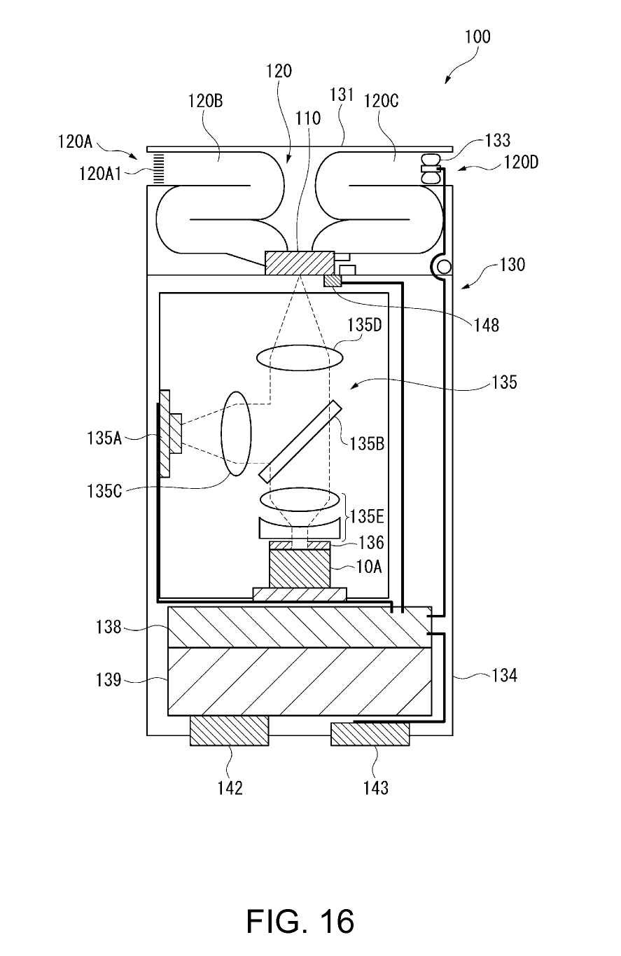

FIG. 16 is a schematic diagram showing an example of a gas detecting device including a variable wavelength interference filter.

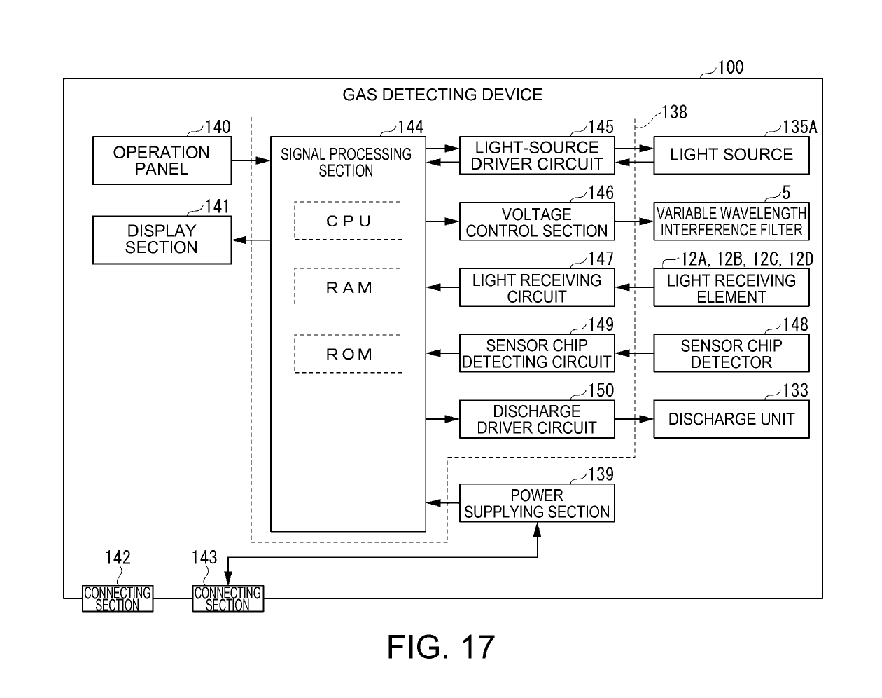

FIG. 17 is a block diagram showing the configuration of a control system of the gas detecting device shown in FIG. 16.

A gas detecting device 100 includes, as shown in FIG. 16, a sensor chip 110, a channel 120 including a suction port 120A, a suction channel 120B, a discharge channel 120C, and a discharge port 120D, and a main body section 130.

The main body section 130 includes a sensor section cover 131 including an opening to which the channel 120 is detachably attachable, a discharge unit 133, a housing 134, a detecting device including an optical section 135, a filter 136, and the optical unit 10A, a control section 138 configured to process a detected signal and control a detecting section, and a power supply section 139 configured to supply electric power. The optical section 135 includes a light source 135A configured to emit light, a beam splitter 135B configured to reflect the light made incident from the light source 135A to the sensor chip 110 side and transmit light made incident from the sensor chip 110 side to the light receiving elements 12A, 12B, 12C, and 12D side, and lenses 135C, 135D, and 135E.

As shown in FIG. 17, on the surface of the gas detecting device 100, an operation panel 140, a display section 141, a connecting section 142 for interface with the outside, and the power supply section 139 are provided. When the power supply section 139 is a secondary battery, the gas detecting device 100 may include a connecting section 143 for charging.

Further, the control section 138 of the gas detecting device 100 includes, as shown in FIG. 17, a signal processing section 144 configured by a CPU or the like, a light source drive circuit 145 for controlling the light source 135A, a voltage control section 146 for controlling the variable wavelength interference filter 5, a light receiving circuit 147 configured to receive signals from the light receiving elements 12A, 12B, 12C, and 12D, a sensor chip detection circuit 149 configured to read a code of the sensor chip 110 and receive a signal output from a sensor chip detector 148 configured to detect presence or absence of the sensor chip 110, and a discharge driver circuit 150 configured to control the discharge unit 133. The gas detecting device 100 includes a storing section (not shown in the figure) configured to store V-λ data. The voltage control section 146 and the signal processing section 144 control, on the basis of the V-λ data stored in a storing section such as a RAM or a ROM, a voltage applied to the electrostatic actuator 56 of the variable wavelength interference filter 5.

The operation of the gas detecting device 100 is explained below.

The sensor chip detector 148 is provided on the inside of the sensor section cover 131 in an upper part of the main body section 130. The sensor chip detector 148 detects presence or absence of the sensor chip 110. When the signal processing section 144 detects a detection signal from the sensor chip detector 148, the signal processing section 144 determines that the sensor chip 110 is attached and outputs, to the display section 141, a display signal for causing the display section 141 to display to the effect that a detection operation can be carried out.

For example, when the operation panel 140 is operated by the user and an instruction signal for starting detection processing is output from the operation panel 140 to the signal processing section 144, first, the signal processing section 144 outputs a signal for light source actuation to the light source driver circuit 145 and causes the light source driver circuit 145 to actuate the light source 135A. When the light source 135A is driven, stable laser light of linear polarized light having a single wavelength is emitted from the light source 135A. A temperature sensor and a light amount sensor are incorporated in the light source 135A. Information of the temperature sensor and the light amount sensor is output to the signal processing section 144. When the signal processing section 144 determines on the basis of temperature and a light amount input from the light source 135A that the light source 135A is stably operating, the signal processing section 144 controls the discharge driver circuit 150 to actuate the discharge unit 133. Consequently, a gas sample including a target substance (gas molecules) to be detected is guided from the suction port 120A to the suction channel 120B, the sensor chip 110, the discharge channel 120C, and the discharge port 120D. A dustproof filter 120A1 is provided in the suction port 120A. Relatively large dust particles and apart of water vapor are removed.

The sensor chip 110 is a sensor in which a plurality of metal nanostructures are incorporated and localized surface Plasmon resonance is used. In the sensor chip 110, when an enhanced electric field is formed among the metal nanostructures by laser light and gas molecules enter the enhanced electric field, Raman scattering light and Rayleigh scattering light including information concerning molecular vibration are generated.

The Rayleigh scattering light and the Raman scattering light are made incident on the filter 136 through the optical section 135. The Rayleigh scattering light is separated by the filter 136. The Raman scattering light is made incident on the variable wavelength interference filter 5. The signal processing section 144 outputs a control signal to the voltage control section 146. Consequently, the voltage control section 146 reads a voltage value corresponding to a measurement target wavelength from the storing section, applies the voltage to the electrostatic actuator 56 of the variable wavelength interference filter 5, and causes the variable wavelength interference filter 5 to split the Raman scattering light corresponding to detection target gas molecules. Thereafter, when the split light is received by the light receiving elements 12A, 12B, 12C, and 12D, a light reception signal corresponding to a light reception amount is output to the signal processing section 144 via the light receiving circuit 147. In this case, it is possible to accurately extract the target Raman scattering light from the variable wavelength interference filter 5.

The signal processing section 144 compares spectrum data of the Raman scattering light corresponding to the detection target gas molecules obtained as explained above and data stored in the ROM, determines whether the gas molecules are target gas molecules, and specifies a substance. The signal processing section 144 displays information concerning a result of the determination on the display section 141 and outputs the information to the outside from the connecting section 142.

In FIGS. 16 and 17, the gas detecting device 100 that splits the Raman scattering light with the variable wavelength interference filter 5 and performs gas detection from the split Raman scattering light is illustrated. However, as the gas detecting device, a gas detecting device that detects light absorbance peculiar to gas to specify a gas type may be used. In this case, a gas sensor that feeds gas into a sensor and detects light absorbed by the gas in incident light is used as the optical module according to the invention. A gas detecting device that analyzes and discriminates the gas fed into the sensor by the gas sensor is the electronic device according to the invention. With such a configuration, it is also possible to detect components of the gas using the variable wavelength interference filter.

Examples of a system for detecting presence of a specific substance include not only the gas detecting device but also substance component analyzing devices such as a noninvasive measurement device for measurement of saccharides by near infrared spectroscopy and a noninvasive measurement device for measurement of information concerning foods, living organisms, minerals, and the like.

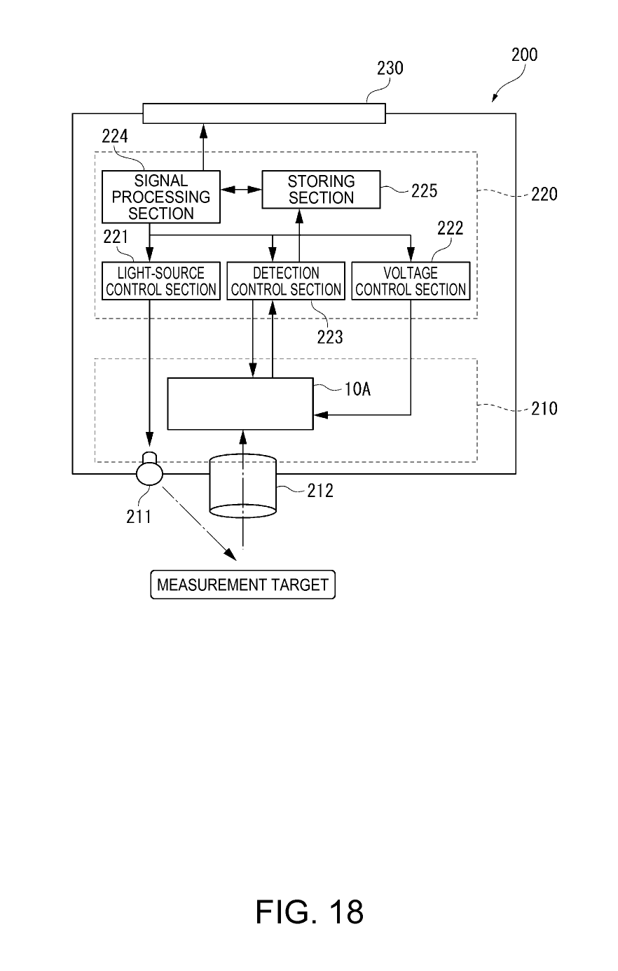

FIG. 18 is a diagram showing the schematic configuration of a food analyzing device, which is an example of the electronic device including the variable wavelength interference filter 5.

A food analyzing device 200 includes, as shown in FIG. 18, a detector 210 (an optical module), a control section 220, and a display section 230. The detector 210 includes a light source 211 configured to emit light, an imaging lens 212 into which light from a measurement target is led, and the optical unit 10A configured to receive the light led into the optical unit 10A from the imaging lens 212.

The control section 220 includes a light-source control section 221 configured to carry out lighting and extinction control and brightness control during lighting of the light source 211, a voltage control section 222 configured to control the variable wavelength interference filter 5, a detection control section 223 configured to control an imaging section 213 and acquire spectral image picked up by the imaging section 213, a signal processing section 224 (a processing control section), and a storing section 225.

In the food analyzing device 200, when the system is driven, the light source 211 is controlled by the light-source control section 221 and light is irradiated on the measurement target from the light source 211. The light reflected on the measurement target is made incident on the variable wavelength interference filter 5 of the optical unit 10A through the imaging lens 212. The variable wavelength interference filter 5 is driven by the driving method explained in the embodiment according to the control by the voltage control section 222. Consequently, it is possible to accurately extract light having a target wavelength from the variable wavelength interference filter 5. The extracted light is imaged by the imaging section 213 configured by, for example, a CCD camera. The imaged light is accumulated in the storing section 225 as a spectral image. The signal processing section 224 controls the voltage control section 222 to change a voltage value applied to the variable wavelength interference filter 5 and acquires spectral images corresponding to respective wavelengths.

The signal processing section 224 subjects data of pixels in the images accumulated in the storing section 225 to arithmetic processing and calculates spectra in the pixels. In the storing section 225, for example, information concerning components of foods with respect to spectra is stored. The signal processing section 224 analyzes data of the calculated spectra on the basis of the information concerning the foods stored in the storing section 225 and calculates food components included in a detection target and contents of the food components. It is also possible to calculate food calories, freshness, and the like from the obtained food components and contents. Further, it is also possible to carry out, for example, extraction of a low freshness portion in an inspection target food by analyzing spectrum distributions in the images. Further, it is possible to perform detection of foreign matters and the like included in the food.

The signal processing section 224 performs processing for causing the display section 230 to display information concerning the components, the contents, the calories, the freshness, and the like of the inspection target food obtained as explained above.

In FIG. 18, an example of the food analyzing device 200 is shown. However, the food analyzing device 200 can also be used as the noninvasive measurement devices for the other information explained above including configurations substantially the same as the configuration of the food analyzing device 200. For example, the food analyzing device 200 can be used as a living organism analyzing device that performs an analysis of living organism components such as measurement and an analysis of components of body fluid such as blood. If the living organism analyzing device that measures components of body fluid such as blood is a device that detects ethyl alcohol, the living organisms analyzing device can be used as a drunken driving preventing device that detects a drunken state of a driver. The living organism analyzing device can also be applied to an electronic endoscope system. Further, the living organism analyzing device can also be used as a mineral analyzing device that carries out a component analysis of minerals.

Further, the optical module and the electronic device according to the invention can be applied to devices explained below.

For example, an optical module can transmit data with lights having respective wavelengths by changing the intensities of the lights having the wavelengths over time. In this case, the optical module can extract data transmitted by light having a specific wavelength by splitting the light having the specific wavelength with a variable wavelength interference filter provided in the optical module and receiving the light with a light receiving section. An electronic device including the optical module for data extraction can carry out optical communication by processing the data of the light having the wavelengths.

The electronic device can also be applied to a spectral camera, a spectral analyzer, and the like that pick up a spectral image by splitting light with the variable wavelength interference filter.

Further, the optical module and the electronic device can be used as a concentration detecting device. In this case, the concentration detecting device splits and analyzes, with the variable wavelength interference filter, infrared energy (infrared light) emitted from a substance and measures subject concentration in a sample.

The optical module and the electronic device according to the invention can be applied to all devices that split predetermined light from incident light. As explained above, the single variable wavelength interference filter can split a plurality of wavelengths. Therefore, it is possible to accurately carry out measurement of spectra of the plurality of wavelengths and detection of a plurality of components. Therefore, compared with the device in the past that extracts a desired wavelength with a plurality of devices, it is possible to promote a reduction in the sizes of the optical module and the electronic device. It is possible to suitably use the optical module and the electronic device as portable and vehicle-mounted optical devices.

Besides, a specific structure in carrying out the invention can be changed as appropriate to other structures and the like in a range in which the object of the invention can be attained.

The entire disclosure of Japanese Patent Application No. 2013-156418 filed on Jul. 29, 2013 is expressly incorporated by reference herein.

What is claimed is:

1. An optical module comprising:
an interference filter including a first reflection film and a second reflection film opposed to the first reflection film, the interference filter transmitting light including peak wavelengths corresponding to a gap dimension between the first reflection film and the second reflection film and respectively corresponding to a plurality of orders; and
a light separating element configured to separate light in a predetermined wavelength band and light in a wavelength band other than the predetermined wavelength band, wherein
a plurality of the light separating elements are provided to respectively correspond to the orders different from one another,
the peak wavelengths corresponding to the orders are included in the predetermined wavelength band in the light separating element, and
the plurality of the light separating elements are arranged in order on an optical path of transmitted light of the interference filter.

2. The optical module according to claim 1, wherein the interference filter includes a light-transmitting member arranged between the first reflection film and the second reflection film.

3. The optical module according to claim 1, further comprising:
a first light-transmitting member configured to cover the first reflection film; and
a second light-transmitting member configured to cover the second reflection film and opposed to the first light-transmitting member via a predetermined optical gap.

4. The optical module according to claim 3, wherein
the interference filter includes a gap changing section configured to change the gap dimension,
the first light-transmitting member and the second light-transmitting member have electric conductivity, and
the optical module includes a capacitance detecting section configured to detect a capacitance between the first light-transmitting member and the second light-transmitting member.

5. The optical module according to claim 1, wherein a singularity of the peak wavelength corresponding to the order in the interference filter is included in the predetermined wavelength band in the light separating element.

6. The optical module according to claim 1, wherein
the light separating element is a dichroic mirror, and
a plurality of the dichroic mirrors are arranged from the interference filter side of the optical path in order from the dichroic mirror having lowest reflectance of light in a wavelength band other than the predetermined wavelength band.

7. An optical module comprising:
an interference filter including a first reflection film and a second reflection film opposed to the first reflection film, the interference filter transmitting light including peak wavelengths corresponding to a gap dimension between the first reflection film and the second reflection film and respectively corresponding to a plurality of orders; and
a light separating element configured to separate light in a predetermined wavelength band and light in a wavelength band other than the predetermined wavelength band, wherein
a plurality of the light separating elements are provided to respectively correspond to the orders different from one another,
the peak wavelengths corresponding to the orders are included in the predetermined wavelength band in the light separating element,
the plurality of light separating elements include:
a first light separating element on which transmitted light of the interference filter is made incident, and
a second light separating element on which light separated by the first light separating element is made incident.

8. An electronic device comprising:
an interference filter including a first reflection film and a second reflection film opposed to the first reflection film, the interference filter transmitting light including peak wavelengths corresponding to a gap dimension between the first reflection film and the second reflection film and respectively corresponding to a plurality of orders;
a light separating element configured to separate light in a predetermined wavelength band and light in a wavelength band other than the predetermined wavelength band; and
a control section configured to control the interference filter, wherein
a plurality of the light separating elements are provided to respectively correspond to the orders different from one another,
the peak wavelengths corresponding to the orders are included in the predetermined wavelength band in the light separating element, and
the plurality of light separating elements are arranged in order on an optical path of transmitted light of the interference filter.
